(19) United States
(12) Patent Application Publication
(10) Pub. No.: US 2017/0098188 A1
(43) Pub. Date: Apr. 6, 2017

(54) SYSTEM AND METHOD OF ENTERING ITEM INTO DISTRIBUTION NETWORK OR SERVICE

(71) Applicant: United States Postal Service, Washington, DC (US)

(72) Inventors: Nii-Kwashie Aryeetey, Washington, DC (US); Robert E. Dixon, JR., Washington, DC (US)

(21) Appl. No.: 15/279,287

(22) Filed: Sep. 28, 2016

Related U.S. Application Data
(60) Provisional application No. 62/236,543, filed on Oct. 2, 2015.

(51) Int. Cl. G06Q 10/08; G06Q 10/10

(52) U.S. Cl. CPC G06Q 10/0833; G06Q 10/109

(57) ABSTRACT

The delivery of items by a distribution service involves processing and handling each of the items being delivered, as well as generating and following a route to deliver each of the items. These routes used by carriers of the distribution service(s) may result in the carriers traveling near or past a majority of or all residences and registered addresses each day or week. Accordingly, the carriers of the distribution service(s) can perform additional services by customers at these residences and addresses with minimal additional burden to the schedule on which the carriers operate. One aspect of the subject matter described in the disclosure provides a method of receiving and transporting an item to a delivery location. An additional aspect of the subject matter described in the disclosure provides a method for performing services at a location.

### CROSS REFERENCE TO RELATED APPLICATIONS

This application claims the benefit of U.S. Provisional Application No. 62/236,543, filed Oct. 2, 2015, and assigned to the assignee hereof. The disclosure of this prior application is considered part of this application, and is hereby incorporated by reference in its entirety.

### BACKGROUND

Field

This disclosure relates to a system and method of providing services by an item carrier to one or more customers along a route, wherein the additional services provided may correlate, at least in part, with information stored and processed by one or more databases.

Description of the Related Art

The delivery of items by a distribution service involves processing and handling each of the items being delivered, as well as generating and following a route to deliver each of the items. These routes used by carriers of the distribution service(s) may result in the carriers traveling near or past a majority of or all residences and registered addresses each day or week. Accordingly, the carriers of the distribution service(s) can perform additional services by customers at these residences and addresses with minimal additional burden to the schedule on which the carriers operate.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include, among other things, efficient provisioning of personalized fitness information.

One aspect of the subject matter described in the disclosure provides a method of receiving and transporting an item to a delivery location. The method comprises receiving, via a customer interface or communication device, a request to transport the item. The request comprises a selection of a courier service or a distribution service, such as a mailing service, logistics service, and the like, by which the customer requests the item be transported and a detailed description of the item to be transported. The method further comprises determining, via a processor, if additional packaging is required for the item to be transported based on the selection of the courier service or the distribution service and based on the detailed description of the item to be transported, selecting, via the processor, additional packaging if the additional packaging is determined to be required, and determining, by a dynamic router, based on the selection of a courier service or a distribution service in the request, whether to modify an existing pickup route or generate a new pickup route and whether to modify an existing delivery route or generate a new delivery route for transportation of the item as requested by the customer. The method also comprises calculating, by the processor, a fee and postage for transporting the item based on the request to transport the item and calculating, by the processor, an estimated delivery date based on the request to transport the item. The method also includes receiving the item, packaging the received item in the additional packaging if the additional packaging is determined to be required based on the selection of a type of courier service or a type of distribution service, and transporting the item to the delivery location according to the selected courier or distribution service for delivery by the estimated delivery date.

An additional aspect of the subject matter described in the disclosure provides a method for transporting an item. The method comprises receiving, via a customer interface or a communication device, a request to perform a service. The request comprises one or more services to be performed at a location or for a customer and the location at which the one or more services are to be performed. The method further comprises determining, via a processor, if additional packaging is required for the item to be transported based on the selection of the courier service or the distribution service and based on the detailed description of the item to be transported and selecting, via the processor, additional packaging if the additional packaging is determined to be required. The method also includes determining, by a dynamic router, based on the selection of a courier service or a distribution service in the request, whether to modify an existing pickup route or generate a new pickup route and whether to modify an existing delivery route or generate a new delivery route for transportation of the item as requested by the customer, calculating, by the processor, a fee and postage for transporting the item based on the request to transport the item, and calculating, by the processor, an estimated delivery date based on the request to transport the item. The method further includes receiving the item, packaging the received item in the additional packaging if the additional packaging is determined to be required based on the selection of a type of courier service or a type of distribution service, and transporting the item to the delivery location according to the selected courier or distribution service for delivery by the estimated delivery date.

Another aspect of the subject matter described in the disclosure includes a system for transporting an item. The system comprises an interface, a processor, a dynamic router, and a delivery resource. The interface is configured to receive a request to perform a service. The received request comprises one or more services to be performed at a location or for a customer and the location at which the one or more services are to be performed. The processor is configured to determine if additional packaging is required for the item to be transported based on a selection of a courier service or a distribution service and based on a description of the item to be transported. The processor is also configured to select additional packaging if the additional packaging is determined to be required and calculate a fee for transporting the item based on the request to transport the item. The dynamic router is configured to determine, based on the selection of the courier service or the distribution service in the request, whether to modify an existing route or generate a new route for transportation of the item as requested by the customer. The delivery resource is configured to receive the item and transport the item to the delivery location in the additional packaging according to the selected courier or distribution service for delivery by the estimated delivery date.

Another aspect of the subject matter described in the disclosure includes an apparatus for receiving and transporting an item. The apparatus comprises means for receiving a request to transport the item. The request comprises a selection of a courier service or a distribution service by which the customer requests the item be transported and a detailed description of the item to be transported. The apparatus further comprises means for determining if additional packaging is required for the item to be transported based on the selection of the courier service or the distribution service and based on the detailed description of the item to be transported. The apparatus also comprises means for determining based on the selection of a courier service or a distribution service in the request, whether to modify an existing route or generate a new route for transportation of the item as requested by the customer. The apparatus further also comprises means for calculating a fee for transporting the item based on the request to transport the item. The apparatus also further comprises means for calculating an estimated delivery date based on the request to transport the item. The apparatus also comprises means for receiving the item, means for packaging the received item in the additional packaging if the additional packaging is determined to be required based on the selection of a type of courier service or a type of distribution service, and means for transporting the item to the delivery location according to the selected courier or distribution service for delivery by the estimated delivery date.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 depicts one embodiment of a system configured to acquire information from one or more modules, store necessary acquired information in one or more modules, and generate one or more actions or routes based at least in part on the acquired and stored information.

FIG. 2A depicts an example of a screenshot of a main screen that may be displayed on a mobile computing device.

FIG. 2B depicts an example of a screenshot of a main screen that may be displayed on a customer interface.

FIG. 3A depicts a flow chart of steps a carrier may perform at a residence with regards to carrier provided services that may be requested by customers and scheduled accordingly via the system 100.

FIG. 3B depicts a decision tree that provides the steps that the carrier may perform for the Carrier Check-in Services described above with reference to FIG. 3A.

FIG. 3C depicts a decision tree that provides the steps that the carrier may perform for the Carrier Commercial Services described above with reference to FIG. 3A.

FIG. 3D depicts a decision tree that provides the steps that the carrier may perform for the Carrier Concierge Services described above with reference to FIG. 3A.

FIG. 3E depicts a decision tree that provides the steps that the carrier may perform for the Carrier Ordered Services described above with reference to FIG. 3A.

FIGS. 4A and 4B depict an exemplary method 400 for receiving, scheduling, and performing a concierge service by a carrier as requested by a customer.

FIGS. 5A and 5B depict a method 500 for scheduling and performing a service by a carrier as requested by a customer.

### DETAILED DESCRIPTION

The features, aspects and advantages of the present development will now be described with reference to the drawings of several embodiments which are intended to be within the scope of the embodiments herein disclosed. These and other embodiments will become readily apparent to those skilled in the art from the following detailed description of the embodiments having reference to the attached figures, the development not being limited to any particular embodiment(s) herein disclosed.

The present disclosure relates to systems and methods for receiving customer requests for services and scheduling and routing carriers to perform the requested services. The systems and methods disclosed herein are configured to receive customer requests and, based on the customer requests and the carrier statuses, schedule and/or route carriers to perform the requested services or inform the customer that the requested service cannot be performed. The customer requests may be related to services already performed by the carrier or may be expanded to include services not generally performed by the carriers for an additional fee. Customers may interact with a system that schedules and controls the carriers via various interfaces.

As used herein, the term “item” may refer to discrete articles in the distribution network, such as mail pieces, letters, flats, magazines, periodicals, packages, parcels, goods handled by a warehouse distribution system, baggage in a terminal, such as an airport, etc., and the like. The term item can also refer to trays, containers, conveyances, crates, boxes, bags, and the like. As used herein, the term “carrier” may refer to an individual assigned to a route who delivers the items to each destination. The term may also refer to other delivery resources, such as trucks, trains, planes, automated handling and/or delivery systems, and other components of the distribution network. The present disclosure also relates to systems and methods to analyze items sent from or received in a geographic area to identify potential information regarding the item that may provide additional revenue streams for the distribution network.

Additionally, as used herein, the term “resident” may refer to any individual or entity that resides, works, visits, or is associated with an address. For example, as used herein, a person at his or her office is a resident, as is a student or teacher at a school. As used herein, a resident can be an entity capable of sending items from an address and receiving items at an address. Additionally, the term “residence” may refer to any building having an assigned physical address, such as a house, an office building, an apartment, a factory, a school, etc. As used herein, a residence can be any location capable of being a destination for items within the distribution network or being a return address for items in the distribution network.

For example, an item delivery (IDS) service such as the United States Postal Service (USPS), the United Parcel Service (UPS), or Federal Express (Fed-Ex) may deliver items (for example, mail), such as letters, flats, etc., according to static routes, and may deliver parcels, packages, and bulky items according to dynamic routes. The United States Postal Service (USPS) will be used in the present disclosure to describe exemplary embodiments, but the present disclosure is not limited thereto. When referencing generically to any of the services listed above or any IDS in addition to those listed above, the phrase “item delivery service or (IDS)” will be used to indicate such generalities.

In some embodiments, customers may request additional services from the carrier, such as item packaging and pickup services or other services typically associated with the distribution service(s) or item carriers. Alternatively, or additionally, the distribution service(s) may provide additional services relating to a benefits and opportunities provided by the fact that the carriers travel to the residences and addresses, such as opportunities for customers to request that the carriers perform courier services, which may include, for example, pickup and drop-off of various goods, etc., such as dry cleaning, medications, food, etc. Systems and methods configured to receive customer requests and to schedule/route carriers based on the customer requests and available services of each carrier are desired.

The USPS delivers items, such as mail and packages, to every physical address in the United States on a daily basis, Monday through Saturday. The USPS is tasked with providing secure, reliable, and affordable delivery of items to every address in the United States, U.S. territories, and U.S. military installations worldwide. For example, the USPS delivers more than 528 million items to over 152 million destinations (addresses) every day. In delivering these items to each of these addresses, in the United States and worldwide, the USPS is in a unique position of being able to gather information regarding these items while they are in transit within the USPS distribution network. For example, the USPS can gather information regarding items received at a residence or by a resident through its distribution network. The USPS may also identify that a residence or more than one residence within a geographic area requests or receives specific periodicals, advertisements, deliveries, or other mail items. Additionally, since most items likely include an indicator of a resident to which they are destined, the USPS may correlate the residence receiving a specific item with the resident that is identified as being the recipient of the item, when possible. Thus, the USPS may generate associations between residents and the residences to which the USPS delivers said items.

A distribution network of may comprise multiple levels. For example, the distribution network may comprise regional distribution facilities, hubs, and unit delivery facilities, or any other desired level. For example, the (nationwide) distribution network may comprise one or more regional distribution facilities having a defined coverage area (such as a geographic area, for example a state or a metropolitan area), designated to receive items from intake facilities within the defined coverage area, or from other regional distribution facilities. The intake facility may function to be the location or facility where individual items are, for the first time in the distribution network, identified and entered into the tracking of the distribution network. The regional distribution facility can sort items for delivery to another regional distribution facility, or to a hub level facility within the regional distribution facility's coverage area. A regional distribution facility can have one or more hub level facilities within its defined coverage area. A hub level facility can be affiliated with a few or many unit delivery facilities, and can sort and deliver items to the unit delivery facilities with which it is associated. In some embodiments, the unit delivery facility may also serve as the intake facility. In the case of the USPS, the unit delivery facility may be associated with a ZIP code. The unit delivery facility can receive items from local senders, and from hub level facilities or regional distribution facilities. The unit delivery facility can also sort and stage the items intended for delivery to destinations within the unit delivery facility's coverage area.

As described above, the distribution network employed may comprise numerous pieces of equipment located in various facilities that may automatically route items according to information indicated on the items, physical characteristics of the items, and/or postage characteristics. For example, a letter mailed from San Diego, Calif., to Washington, D.C., with First Class postage may be routed differently than a large package mailed between the two locations. Similarly, a second letter mailed with Next Day postage may be routed differently than the letter mailed with First Class postage. The variety of potential routes for different types of items or different postage services indicates the benefit of distributing a system throughout the distribution network (for example in multiple intake and unit delivery facilities) to maximize the amount of information gathered by the system to associate with residences and addresses.

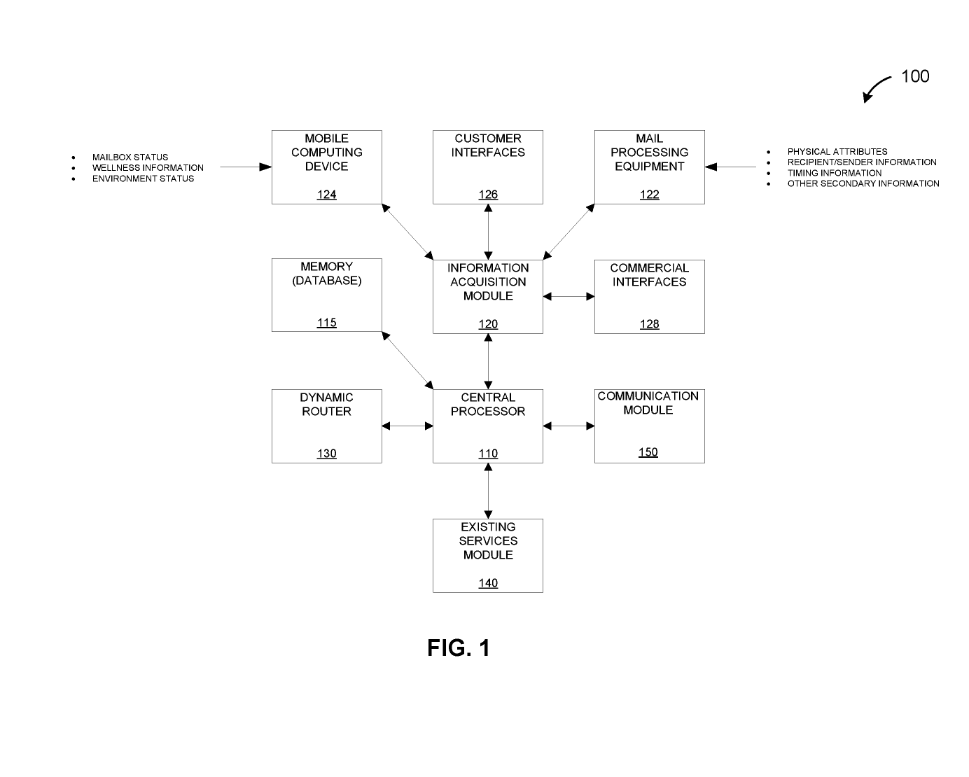

FIG. 1 depicts one embodiment of a system configured to acquire information from one or more modules, store necessary acquired information in one or more modules, and generate one or more actions or routes based at least in part on the acquired and stored information. The system 100 comprises a central processor 110, a memory (database) 115, an information acquisition module 120, a dynamic router 130, an offered services module 140, and a communication module 150. In some embodiments, more or fewer components may be included in the system 100. The information acquisition module 120 may comprise item processing equipment 122 (or one or more pieces of item processing equipment 122), one or more mobile computing devices 124, one or more customer interfaces 126, and one or more commercial interfaces 128. The system 100 may be implemented at any level of the distribution network described above, such as in a unit delivery facility, a hub level facility, a regional distribution center, or a national distribution network control level. In some embodiments, the system 100 and/or the various components therein may be distributed between one or more levels of the distribution network described above. For example, the system 100 may have one or more components in a unit delivery facility and may have other components in more than one other facility, for example in the regional distribution center. In some embodiments, one or more of the modules described above may not be distributed within the distribution network described above. In some embodiments, one or more of the modules may be located outside the distribution network (for example, the customer interfaces 126 or the commercial interfaces 128).

In some embodiments, the national distribution network may comprise one or more systems 100. In some embodiments, the national distribution network may comprise a single system 100 with one central processor 110 and one memory 115 in communication with each other module of the system 100, where each other module may service a portion of the national distribution network. Accordingly, the one central processor 110 and the one memory 115 may be configured to connect and communicate with multiple information acquisition modules 120, dynamic routers 130, offered services modules 140, and communication modules 150. In some embodiments, the single system 100 may comprise the one central processor 110, the one memory 115, one information acquisition module 120, one dynamic router 130, one offered services module 140, and one communication module 150. However, the one information acquisition module 120 may be configured to interface with and communicate with the one or more mobile computing devices 124, the one or more customer interfaces 126, the one or more pieces of item processing equipment 122, and the one or more commercial interfaces 128. Accordingly, these modules configured to interface and communicate with the one information acquisition module 120 may be distributed within the various levels and regions of the national distribution network.

In some embodiments, multiple systems 100 may be implemented at a local level, each system 100 of the multiple systems 100 having its own central processor 110 and memory 115, in addition to the modules described above. For example, one or more of the modules of the system 100 may be distributed between one or more of the unit delivery facility, the hub level facility, and the regional distribution facility. The multiple systems 100 may then communicate with each other as necessary. In some embodiments, such a distribution of multiple systems 100 may prove to be more efficient than having a single, centralized system that each of the modules must communicate with. In some embodiments, the modules associated with information acquisition may be distributed at lower levels of the distribution network described above, while the dynamic router 130, offered services module 140, and communication module 150 may be distributed at higher levels of the national distribution network. For example, the information acquisition modules 120 (and the corresponding mobile computing devices 124, customer interfaces 126, item processing equipment 122, and commercial interfaces 128) may be implemented at intake facilities (or other lower level or external locations), thus allowing the information acquisition modules 120 to collect information from a variety of locations in the distribution process or even external to the distribution process. These information acquisition modules 120 may be in communication with one or more central processors 110, memory 115, revenue modules 140, information analysis modules 130, and communication modules 150, which may be located at different levels than the information acquisition modules 120, for example distributed in the hub level facilities and/or the regional distribution facilities.

In some embodiments, the system 100 may have a single central processor 110 and memory 115 with multiple information acquisition modules 120, dynamic router 130, offered services module 140, and communication module 150, all of which are interconnected. The central processor 110 and memory 115 may be configured to interact and communicate with each of the other modules, wherein each of the other modules may service defined coverage areas, such as a specified geographic region. For example, a state or a city may comprise a collection of information acquisition modules 120, the dynamic router 130, the offered services module 140, and the communication module 150, that each communicates to the central processor 110 and the memory 115. For ease of discussion herein, the system 100 will be described with reference to its use in a unit delivery facility. Accordingly, other unit delivery facilities may have their own systems 100, where the individual memory 115 and the central processor 110 for each system correspond to the specified geographic regions. In some embodiments, the multiple systems 100 each comprise central processors 110 may share a single memory 115. In some embodiments, the multiple systems 100 each have individual memory 115 but all share a single central processor 110. In some embodiments, the multiple systems 100 each have individual memories 115 and individual central processors 110 but are still interconnected via one or more wired or wireless communications systems. For ease of discussion herein, the system 100 will be described with reference to its use in a unit delivery facility.

The central processor 110 can be embodied on a computer or a server which communicates via wired or wireless link to the memory and modules of the system 100. The central processor 110 may be configured to interface with each of the memory 115, the information acquisition module 120, the dynamic router 130, the offered services module 140, and the communication module 150. In some embodiments, the central processor 110 can be remote to the unit delivery facility in which the remaining modules of the system 100 are associated, and may service more than one unit delivery facility (for example, the central processor 110 may be on a computer or server within the regional distribution facility). The central processor 110 may control and/or direct the operation of the components of the system 100. The communications between the various modules of the system 100 described below may occur via the central processor 110 (as shown in FIG. 1) or may occur directly between the various modules (not shown in FIG. 1). In some embodiments, all processing for the various modules of the system 100 may be performed by the central processor 110. In some embodiments, the central processor 110 may not be responsible for any processing for the various modules of the system 100, and each module of the system 100 may be configured to handle its own processor or perform joint processing with other modules.

The memory 115 is in communication with the central processor 110, the information acquisition module 120, the dynamic router 130, the offered services module 140, and the communication module 150. The memory 115 can store data and information, such as in a household database, a relational database, or in any other information storage format, such as comma delimited, etc. The memory 115 can also store the operating instructions for the modules of the system 100. In some embodiments, the memory 115 may comprise an individual computing system configured to store information having its own processor and communication modules. The memory 115 may be configured to store data and information from one or more of the modules of the system 100, including the mobile computing devices 124, the customer interfaces 126, the item processing equipment 122, and the commercial interfaces 128.

The information acquisition module 120 may comprise a computer, a processor, software running on the central processor 110, or the like. In some embodiments, the information acquisition module 120 may be integrated with one or more other modules of the system 100. Additionally, the information acquisition module 120 may comprise one or more sensors, cameras, connections with sensors, or connections with cameras, or other input devices configured to identify and capture information. In some embodiments, the information acquisition module 120 may receive signals from various connected modules. The signals from these connected modules may provide information that may be used by the system 100.

The information acquisition module 120 may receive signals from item processing equipment 122. The item processing equipment 122 may comprise sensors, cameras, or a computer, a processor, software running on the central processor 110, or the like. In some embodiments, the item processing equipment 122 may be integrated with one or more other modules of the system 100. The item processing equipment 122 may be configured to receive one or more signals from one or more sensors, cameras, connections with sensors or connections with cameras or other input devices configured to identify and capture physical attributes of the item. In some embodiments, the item processing equipment 122 may be integrated into one or more pieces of item handling equipment utilized by the IDS. In some embodiments, the item processing equipment 122 may interface with the one or more pieces of item handling equipment such that sensors, cameras, etc., of the item handling equipment are used for the item processing equipment 122 as well. The signals received by the item processing equipment 122 may include inputs or signals comprising, for example, a mass or weight of the item, dimensions of the item, shape of the item, or physical markings on the item (such as a logo or description of the contents or a decorative bow or wrapping paper or infrared (or other non-visible) markings). In some embodiments, the item processing equipment 122 may be configured to communicate the received inputs or signals to the information acquisition module 120.

The information acquisition module 120 may further receive signals or inputs from one or more mobile computing devices 124. The one or more mobile computing devices 124 may comprise a mobile device (for example, a cell phone or a PDA), a computer, a processor, software running on the central processor 110, or the like. In some embodiments, the one or more mobile computing devices 124 may be integrated with one or more other modules of the system 100. The one or more mobile computing devices 124 may represent input mechanisms or modules allowing the carrier handling the item to provide input to the system 100. In some embodiments, the one or more mobile computing devices 124 may include a camera or other image or multimedia capturing functionality such that the carrier may provide picture or other multimedia inputs to the system 100. In some embodiments, the mobile computing devices 124 may further include text input capabilities (such as a physical or touchscreen keyboard), such that the carrier may input descriptions or various text phrases into the system 100. In some embodiments, the mobile computing device 124 may comprise multiple pieces of hardware (for example a camera and a PDA) or may be integrated into a single piece of hardware (for example, a smartphone, a tablet, a computer, or a tablet computer, etc.).

The information acquisition module 120 may further receive signals or inputs from one or more customer interfaces 126. The one or more customer interfaces 126 may comprise a device (for example, a cell phone, tablet, or a PDA, etc.) sensors, cameras, or a computer, a processor, software running on the central processor 110, or the like. In some embodiments, the one or more customer interfaces 126 may be integrated with one or more other modules of the system 100. The one or more customer interfaces 126 may represent input mechanisms or modules allowing customer interaction with the system 100. For example, the customer interface 126 may provide a customer the ability to request services from the system 100 or to manage an account with the IDS. In some embodiments, the customer interface 126 may allow the customer to receive communications from the system 100 or the IDS or to send a communication to the system 100 or the IDS. In some embodiments, the customer interface 126 may allow the customer to interact with one or more other services or systems of the IDS.

The information acquisition module 120 may further receive signals or inputs from one or more commercial interfaces 128. The one or more commercial interfaces 128 may comprise a device (for example, a cell phone, a PDA, or a register, etc.), sensors, cameras, a website API, or a computer, a processor, software running on the central processor 110, or the like. In some embodiments, the one or more commercial interfaces 128 may be integrated with one or more other modules of the system 100. The one or more commercial interfaces 128 may represent input mechanisms or modules allowing commercial entity and/or customer interaction with the system 100. For example, the commercial interface 128 may allow a customer to request services from the system 100 or may allow a commercial entity to provide and/or receive information to/from the system 100 and/or the IDS. In some embodiments, the commercial interface 128 may allow the customer to receive communications from the system 100, the IDS or the commercial entity, or to send a communication to the system 100, the IDS, or the commercial entity. In some embodiments, the customer interface 128 may allow the customer to interact with one or more other services or systems of the IDS.

The dynamic router 130 may comprise a computer, a processor, software running on the central processor 110, or the like. In some embodiments, the dynamic router 130 may be integrated with one or more other modules of the system 100. The route planning and schedule module 130 may receive communications from one or more of the other modules of system 100. The dynamic router 130 may provide for the routing and scheduling of carriers and/or items in the IDS. In some embodiments, the dynamic router 130 may be configured to generate future routes and schedules based on information received regarding type information, quantity information, source/destination information, physical attribute information, or carrier availability information. In some embodiments, the dynamic router 130 may be configured to generate real-time routes and schedules based on received information regarding current requests, available resources, current commitments, etc. The routes and schedules generated by the dynamic router 130 may be configured to apply to one or more carriers or other service providers associated with the system 100.

The offered services module 140 may comprise a computer, a processor, software running on the central processor 110, or the like. In some embodiments, the offered services module 140 may be integrated with one or more other modules of the system 100. The offered services module 140 may be configured to receive communications and/or information from one or more of existing services offered by the system 100. The offered services module 140 may facilitate the integration of the various modules described herein with existing systems 100.

The communication module 150 comprises a module that is configured to allow any component of the system 100 to communicate with one or more devices and modules external to the system 100. For example, the communication module 150 may provide wireless or wired communication capabilities with a communication module 150 of another system 100 or with a third party. The communications with the third party may be via the Internet or a similar network type connection. The communication module 150 may be configured to receive communications from third parties, for example, requests and queries for analysis of the household database. The communication module 150 may also be configured to transmit the results of the requests and queries for analysis to third parties. The communication module 150 may also communicate with other systems of the IDS, for example the systems that control the services that the IDS provides. The communication module 150 may be configured to provide communications for each of the components of the system 100. The communication module 150 may also be configured to allow the modules of the system 100 to access external resources, such as the Internet or a local network, etc.

The system 100 may utilize the modules described above to implement a system configured to and capable of providing additional services to an existing IDS allowing the IDS to provide additional value-added features and services to its customers. For example, the IDS may be in a unique position to provide customers opportunities to streamline the process of entering items into the item stream (or distribution stream) and/or receiving items from the distribution stream. Additionally, the IDS may provide customer opportunities to receive additional services that the IDS may be in unique position of providing. For example, as the IDS may often comprise countless carriers that cover a large geographic area on a frequent basis (for example, weekly or daily), the IDS may be able to utilize those carriers and the covered area to provide services to the existing customers. Additionally, as the IDS may provide governmental services to customers and entities, for example, passport services (e.g., intake, generation, and delivery of passport requests and completed passports), election services (e.g., election propaganda, election materials, absentee ballots), etc., the system 100 may facilitate extending the provision of these (and other) services to the residential and commercial locations of customers. For example, the system 100 may allow a carrier to provide postage or passport services at a doorstep of a residence of a customer, thereby saving the customer from having to make a trip an establishment operated by the IDS (such as a local Post Office). The various modules disclosed herein in reference to FIG. 1 may facilitate the providing of these additional services in an efficient and cost-effective manner.

The information acquisition module 120 may serve to assist in the identification and gathering of information for use by the system 100. For example, the information acquisition module 120 may be configured to receive information regarding services requested by one or more customers, to receive information from one or more customers regarding their account or profiles, or to provide information to one or more customers regarding existing service requests, among other information. In some embodiments, the information acquisition module 120 may be configured to receive information from one or more carriers regarding current services being implemented by the carrier or regarding requests received from the carrier. In some embodiments, the information acquisition module 120 may be configured to provide acquired information to the carriers to facilitate the providing of services to customers (for example providing a carrier a list of requested services along the carrier's route so that the carrier may obtain any required materials or supplies needed for the requested services before the carrier begins an assigned route).

As described in brief above, the information acquisition module 120 may be configured to receive information from and send information to item processing equipment 122. The item processing equipment 122 may be configured to acquire information from items, communications, and third parties for storage in the memory 115 and use by the system 100. The item processing equipment 122 can be embodied in one or more pieces of item handling equipment, item scanners, sorting equipment, or other devices used to process and handle items being distributed via the distribution service or distribution network, for example a handheld scanner or a barcode scanner operated in a hub facility. For example, the item processing equipment 122 may be embodied in equipment configured and designed to scan items and acquire information of the items (for example, equipment that can identify, scan, and perform optical character recognition (OCR) on destination and return address information). The item processing equipment 122 may comprise a vision or camera system configured to identify and/or capture address information and other information located on or associated with items to be distributed. In some embodiments, the item processing equipment 122 comprises any other means for identifying and capturing information about items being distributed. In some embodiments, the item processing equipment 122 may share equipment used to identify items for services of the item delivery (for example, equipment used to identify items for address change, temporary mail hold, or forwarding services). These existing services may currently identify and acquire address information to perform the requested services. Such shared use with existing technologies may reduce costs and simplify integration of the system 100.

In some embodiments, the item processing equipment 122 may be remotely located, for example on a mobile device utilized by a mobile carrier or a customer's mobile device. For example, a mobile device (for example, a smart phone, a tablet, a laptop, a remote station, an augmented reality device, or the like) may provide real-time information regarding services to be provided along a route of the distribution service. The item processing equipment 122 which may operate on the carrier's mobile device may allow the carrier to capture information for items to be entered into the distribution stream (for example, one or more items collected from a customer for delivery by the IDS) or may allow the modification of information regarding an item already entered into the distribution stream (for example, allowing a customer to adjust delivery instructions for an item). Accordingly, the item processing equipment 122 may be integrated with the mobile computing device 124 to facilitate services provided by the carrier and to reduce costs. Accordingly, in some embodiments, the mobile device utilized by the mobile carrier (as will be described in more detail below) may be used in the distribution service.

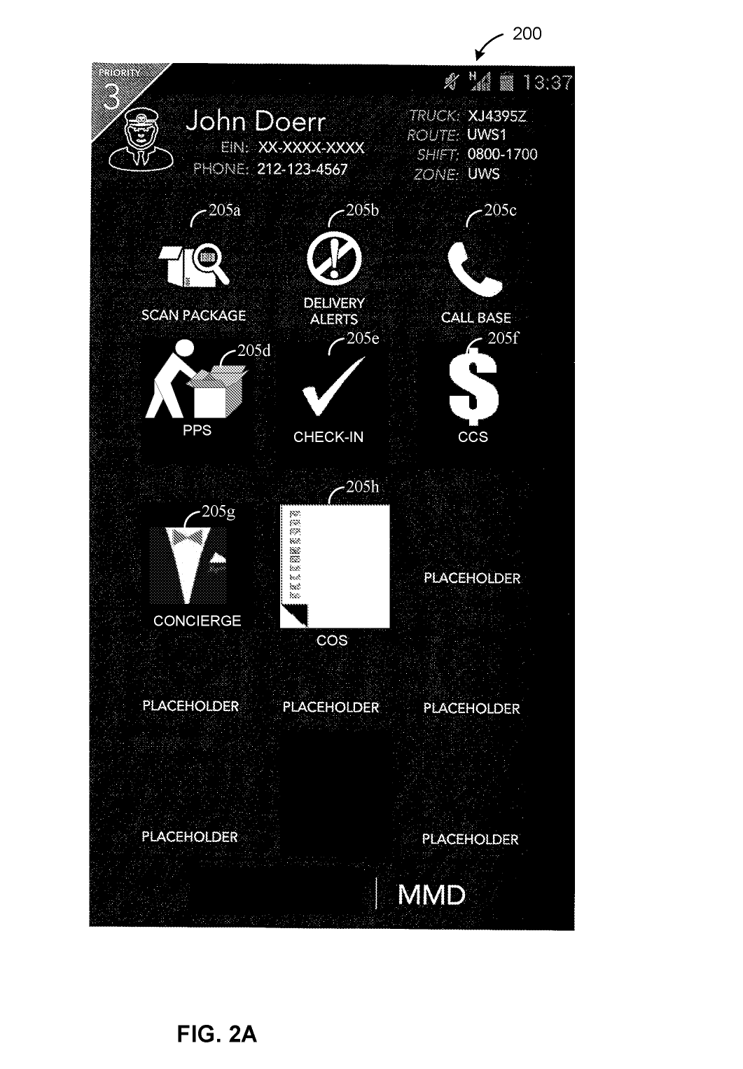

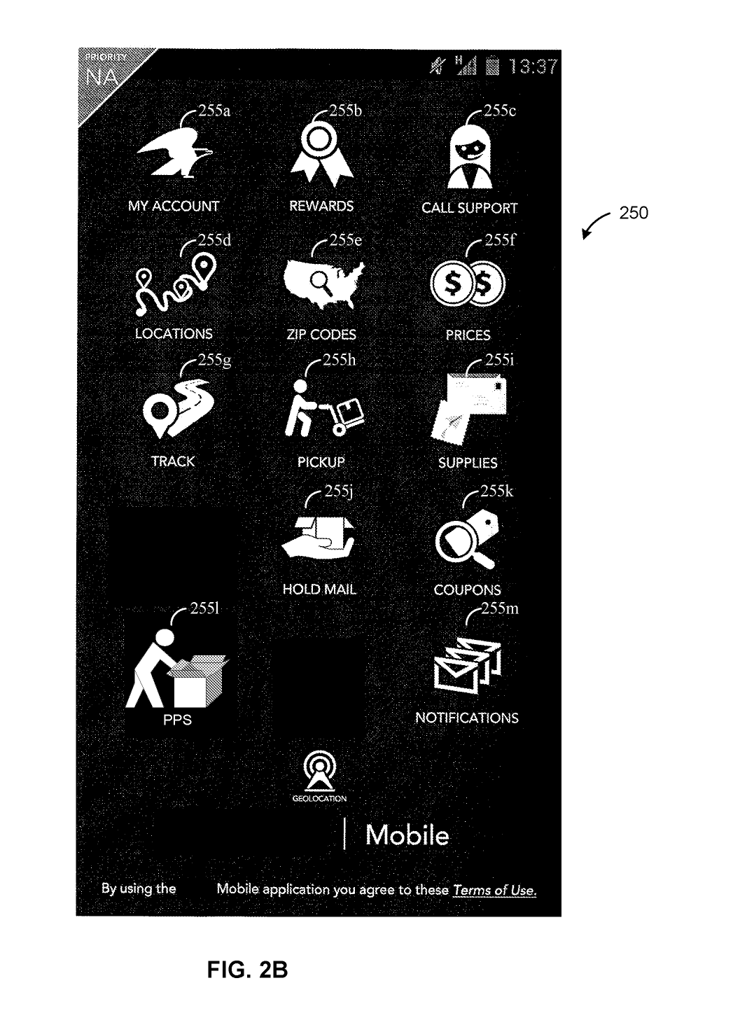

The one or more mobile computing devices 124 may be configured to facilitate the providing of services to a customer by a carrier. For example, the mobile computing device 124 may allow the carrier to interact with requests generated by one or more customers. For example, if a customer has requested a package and pickup service (PPS) for an item, and the carrier is scheduled to perform the PPS, then the mobile computing device 124 may provide the carrier with the information needed to perform the PPS. In some embodiments, the mobile computing device 124 may be configured to receive real-time updates regarding PPS or other service requests from customers along the carrier's route. Alternatively, the mobile computing device 124 may be configured to update a list of scheduled service requests at the end of a route (in preparation for the following day's route) or at the beginning of a route. The mobile computing device 124, in displaying the service request, may provide the carrier with the address at which the item(s) for the PPS are located, turn-by-turn navigation instructions, and the destination(s)/service(s) requested so that the carrier can properly receive and intake the item(s) into the distribution stream and/or deliver or disposition of the item(s). In some embodiments, a screen as shown in FIG. 2A may be shown on the one or more mobile computing devices 124. In some embodiments, the dynamic router may provide the carrier with information to help prepare for services to be performed along the carrier's route for the following day, etc.

FIG. 2A depicts a main screen 200 of an exemplary interface of a mobile computing device 124 that may be used by a carrier that performs services along a specific route. The main screen 200 shows various applications that may be activated on the mobile computing device 124 of the carrier of the IDS. In some embodiments, more or fewer applications may be provided on the mobile computing device 124. As shown in FIG. 2A, the mobile computing device 124 may indicate the carrier's identification (for example, name 201a, employee number 201b, phone number 201c, etc.) and the carrier's route information 202a, vehicle information 202b, shift information 202c, and coverage area or zone 202d. In some embodiments, more or less information may be shown on the carrier information. In some embodiments, though not shown in this figure, the mobile computing device 124 may be secured such that only the actual carrier may access the mobile computing device 124. Such security may be implemented in any manner, for example an alphanumeric password, a biometric identifier, a physical identification device (RFID card, NFC badge, etc.), or the like.

Selection of one or more applications from the main screen 200 may provide the carrier with a screen specific to that application(s) and may provide the carrier with details as to open requests along the carrier's route associated with that application. For example, the application “PPS” may be associated with customer requests for package and pickup services, and when selected by the carrier, may provide the carrier with a list of “open” or unfulfilled package and pickup requests along the carrier's route. In some embodiments, the carrier may be able to select individual requests from the list shown on the mobile computing device 124 and view details of the request, for example size, delivery options, location, etc. Additionally, or alternatively, the PPS application on the mobile computing device 124 may be configured to allow the carrier to review requests/details of requests that have been completed. Alternatively, or additionally, the carrier may receive alerts or notifications as to updates regarding assigned tasks. For example, the carrier may receive, via the mobile computing device 124, the alerts or notifications that a new request for package pickup services has been received. In some embodiments, these alerts or notifications may be received dynamically regardless of the screen displayed on the mobile computing device 124. In some embodiments, the alerts may pop-up or otherwise be displayed to the carrier in a non-screen specific manner, while in other embodiments, the alerts may also or instead be displayed in a list format that allows the carrier to navigate to a specific screen (for example, via the delivery alerts link 205b). The alerts or notifications may be broadcast or otherwise transmitted to the mobile computing device 124 by the IDS that has been requested to perform the package pickup service request.

In some embodiments, the mobile computing device 124 may comprise a camera, a barcode scanner, a keyboard, or any other means for inputting information into the mobile computing device 124. Such input capabilities may be used by the carrier to provide information to the IDS regarding the service being performed by the carrier (for example, details of an item being picked up and packaged or a photo of the item once packaged and/or delivered). The mobile computing device 124 may be configured to provide any information input by the carrier to the IDS via communications with the information acquisition module 120 or the communication module 150 or any other module of the system 100.

The one or more customer interfaces 126 may be configured to receive customer requests for services from the system 100. For example, the customer interface(s) 126 may be configured to input and/or receive information from customers regarding requested services or general information regarding the IDS. For example, FIG. 2B depicts an example of a screenshot 250 that may be provided on a mobile interface of the customer interface 126. The screenshot 250 is an example of a screen where the customer interface 126 is embodied as an application on a user's cell phone, PDA, laptop, desktop computer, tablet, or any other electronic communication means. Selection of one or more of the icons (or shortcuts) showed on the screenshot 250 may open the application allowing the customer to interact with the IDS via an associated communication system. For example, if the user selects the “My Account” icon may present the user with his/her account information via an associated system of the IDS. Similarly, selection of the “Hold Mail” icon may provide the customer with access to an associated system of the IDS that allows the user to enter a new or modify an existing mail hold request. Selection of the package and pickup service (PPS) icon may provide the customer with access to the associated system that allows the customer to create, modify, or check the status of a PPS request.

The customer interfaces 126 may be configured to interact with the information acquisition module 120 of the system 100. Alternatively, or additionally, the customer interfaces 126 may interact with the communication module 150 or the central processor 110 or any other module of the system 100. The customer interfaces 126 may allow one or more customers to interact with the system 100 and receive communications and/or notifications from the system 100 such that the customer and the system 100 may provide updates regarding requested services, such as status, completion, newly created, etc. The potential mobility of the customer interfaces 126 may facilitate interactions between the system 100 and the customer(s) by reducing delays in communications between the customer(s) and the system.

The commercial interfaces 128 may be configured to allow commercial entities to provide information to the system 100. For example, one or more customers may create a request using their customer interfaces 126 to have a carrier pick up a specific item, such as medications from a pharmacy for the customer, clothing from a dry cleaner or tailor, food from a grocery store, takeout from a restaurant, etc. The pharmacy may use the commercial interface 128 to acknowledge and/or confirm, with both the customer and the carrier (and/or IDS or system 100), that the carrier is authorized to pick up the customer's medications. Additionally, the commercial interface 128 may be used by the pharmacy to indicate when the customer's medications are ready to be picked-up by the carrier for delivery to the customer.

In some embodiments, the commercial interface 128 may comprise a smart phone, a tablet, a cash register, a computer, a laptop, a website, or any similar means for electronic communications and data entry. The commercial interface 128 may be configured to communicate with the system 100 via the information acquisition module 120, the communication module 150, and/or any other module of the system 100.

As discussed above, the dynamic router 130 may be configured to provide for the routing and scheduling of carriers and/or items in the IDS. The routing and scheduling provided by the dynamic router 130 may depend on the service(s) requested by the customer, the time of day and/or urgency of the customer request, and/or the carrier(s) available to perform the requested service. For example, if the customer creates and submits a request for the package and pickup service with a non-urgent requested delivery date (for example, within the continental United States within the next two weeks), then the dynamic router 130 may generate a route and schedule having a carrier pickup and package the item within a window of a few days. Alternatively, or additionally, if the customer request is urgent and/or the delivery date is urgent (for example, for the PPS), then the dynamic router 130 may be configured to generate a more urgent route and schedule for a carrier to perform the PPS. In some embodiments, the dynamic router 130 may be configured to modify an existing route and/or schedule based on a customer request and the existing route and/or schedule.

In some embodiments, the system 100 (and/or the dynamic router 130) may be configured to place restrictions on customer requests for purposes of proper scheduling. For example, in some embodiments, the system 100 may have an established cut-off time or threshold time after which new requests for the same day (or the next day) will not be accepted due to scheduling and routing constraints. Such constraints may include the time needed to generate a schedule and route that is properly balanced such that the carrier servicing the route and/or schedule is not overworked and is able to perform the requested tasks with their associated equipment. For example, the carrier must be able to pick up all requested items and have sufficient space in the vehicle to perform all routine and additionally requested tasks (such as pickup of items, storage of items to be delivered, etc.). Alternatively, or additionally, if the customer has an urgent request (for example, the customer urgently needs a prescription pickup from the pharmacy and delivered the same day), then the dynamic router 130 may be configured to generate an urgent route and/or schedule for a carrier to perform. In some embodiments, when the route and/or schedule are urgent, a special “urgent” carrier may be dispatched to perform the urgent route and/or schedule. In some embodiments, the dynamic router 130 may be configured to generate an urgent route and/or schedule utilizing the most convenient (i.e., closest) carrier for the pharmacy and/or customer. In some embodiments, the dynamic router 130 may be configured to utilize more than one carrier to perform a single request. For example, the dynamic router 130 may utilize a first carrier to pick up medications from the pharmacy and coordinate a meeting between the first carrier and a second carrier, and the second carrier may deliver the medications to the customer. The dynamic router 130 may communicate the additional task(s) to the carrier via an alert or notification system. The dynamic router 130 may be configured to broadcast or transmit the alerts or notifications via the alert or notification system to the mobile carrier device 124 as discussed above. The dynamic router 130 may send the alerts or notifications instructing the receiving carrier to perform one or more additional tasks as requested by one or more customers along the route of the carrier.

In some embodiments, the dynamic router 130 may be configured to consider various factors when generating a route and schedule based on customer requests. For example, the various types of requests and potential deadlines or requested dates may play a role in the generating of the route and schedule. Additionally, depending on the service being request and/or the client's account, additional services may be scheduled prior to or in conjunction with the requested services. For example, if the customer creates a new account and requests one of a specific type of service (for example, medication pickup or governmental services), the route planning and scheduling service may schedule a verification appointment such that the customer's identify can be verified for purposes of services to be performed by the IDS carrier on behalf of the customer. Additionally, the dynamic router 130 may need to account for equipment constraints in planning routes and schedules. For example, specific equipment may be needed to perform some services, for example passport services and/or disposal of specific items. Accordingly, the dynamic router 130 may be configured to account for such constraints and generate routes and schedules accounting for any constraints. Once the dynamic router 130 generates a route and/or schedule, the generated route and/or schedule is communicated to the system 100 and eventually may be communicated to the mobile computing devices 124 of the carriers affected by the route and/or schedule. In some embodiments, a notification of the generated route and/or schedule may be communicated to the customer via the customer interface 126 such that the customer may be able to track progress on his/her request. In some embodiments, the carrier that receives one or more additional tasks for customer requests from the dynamic router 130 may need additional time to complete the requested additional tasks. The dynamic router 130 may update the time allotted to the carrier for performing the requested tasks based on the additional tasks requested. However, the additional time required for the requested additional tasks may cause other appointments or other tasks of the carrier later in the route to become delayed. In some embodiments, the dynamic router 130 may automatically adjust the carrier's route and/or schedule to accommodate any delays introduced by additional customer requests. In some embodiments, the dynamic router 130 may update the carrier's route and/or schedule to assign another carrier to at least a portion of the carrier's remaining route and/or schedule.

In some embodiments, the dynamic router 130 may be configured to generate a route and/or schedule for one or more carriers such that the carriers are routed and scheduled to meet each other to facilitate an exchange of items and/or goods based on which carrier may more efficiently perform given requests. For example, if a first carrier services a route having a customer that requests a medication pickup/delivery from a given pharmacy, but a second carrier services a route having the pharmacy, then the dynamic router 130 may schedule the second carrier to pick up the medication from the pharmacy. The dynamic router 130 may then schedule/route the first and second carriers to meet at a location that is convenient to both carriers' routes, where the first and second carriers exchange the medication, and then schedule the first carrier to deliver the medication to the requesting customer.

As discussed above, the offered services module 140 may be configured to receive communications and/or information from one or more of existing services offered by the system 100. For example, the offered services module 140 may involve the mail hold or address change services already provided by the IDS. Alternatively, or additionally, the offered services module 140 may further comprise any systems involved in governmental services currently offered by the IDS, for example passport services and/or voter registration, and/or election material distribution. Such integration of the offered services module 140 with the system 100 may allow the system 100 to integrate provision of additional services with existing services and appropriately planning routes and/or schedules based on any available services. Additionally, such integration of offered services module 140 and corresponding background services may allow the system 100 to expand providing of the existing services by carriers to customers by request. Thus, when the carrier provides an existing service to the customer (for example, passport services at the customer's residence), the integration of the offered services module 140 with the system 100 may allow the carrier to communicate directly with the offered services module 140 to provide required information to the offered services module 140 and receive any prompts necessary to facilitate providing of the existing service to the customer.

As described above, FIG. 2A depicts an example of a screenshot of a main screen 200 that may be displayed on a mobile computing device 124. The main screen 200 depicts information for the carrier (e.g., name, phone number, etc.) as well as access to various applications via icons 205a-205d. As shown, more or fewer icons providing access to additional or fewer applications may be included on the main screen 200. Icons 205a-205d may provide access to a “Scan Package 205a,” “Delivery Alerts 205b,” “Call Base 205c,” and “PPS 205d” applications, respectively. The “Scan Package 205a” application may provide the carrier the ability to scan a barcode or other identifying information on an item and identify various information regarding the item from the scan. In some embodiments, the scan may be replaced by a picture, video, or other visual sensing means. The “Delivery Alerts 205b” application may provide the carrier with a list of scheduled deliveries or delivery reminders of upcoming deliveries. As discussed above, the “Delivery Alerts 205b” application may display dynamic alerts or notifications received for added customer requests. The “Call Base 205c” application may allow the carrier to call the local or dispatching office of the IDS or a central office. The “PPS 205d” application may provide the carrier with information regarding PPS requests received from customers along the carrier's route. In some embodiments, the carrier may have to access the PPS application via the link 205d in order to receive updates of requests for PPS. In some embodiments, as discussed above, the carrier may receive updates, alerts, and/or notifications on the main screen 200 regarding customer initiated requests or updates. The updates, alerts, and/or notifications may be initiated by the customer via the customer interface 126 or by the IDS via the communication module 150. In some embodiments, any notifications, updates, etc., received by the carrier via the mobile computing device 124 with regards to the PPS may be received via communications with the information acquisition module 120 and/or communication module 150.

When the carrier accesses the PPS application via the icon 205d, the carrier may be provided with options regarding the PPS. For example, the carrier may be provided with a list of PPS requests that are on the carrier's route or which the IDS identified with an alert, and the carrier may be able to select any of the PPS requests to access details of the PPS request. The details of the PPS request may include the location where the item for the PPS (the package to be packed and shipped by the IDS) is located, details on the shipping methods, dates, etc., details on the physical parameters of the item, etc. Access to these details may allow the carrier to manipulate his/her schedule and/or route based on conditions known only to the carrier or to obtain necessary equipment or materials to perform the PPS. In some embodiments, if the carrier scheduled to perform the PPS does not have the necessary equipment and/or materials on his/her vehicle, the customer that requested the PPS may be notified by the PPS via the customer interface 126 that the PPS will be delayed a day or the customer may be contacted via the customer interface 126 to request if a delay is acceptable. In some embodiments, the customer may provide additional contact information by which the customer may be contacted with regards to updates or potential issues with the customer requested service. In some embodiments, different PPS requests may be given different priorities based on any number of factors, and the priorities may impact how different PPS requests are handled. For example, in some embodiments, PPS requests from frequent customers may be given a higher priority than a PPS request from a less frequent customer. Alternatively, or additionally, priorities may be assigned based on details of the item, for example, if the item is perishable or if the delivery date is non-negotiable, the item may be given a higher priority than something non-perishable or something with a negotiable delivery date.

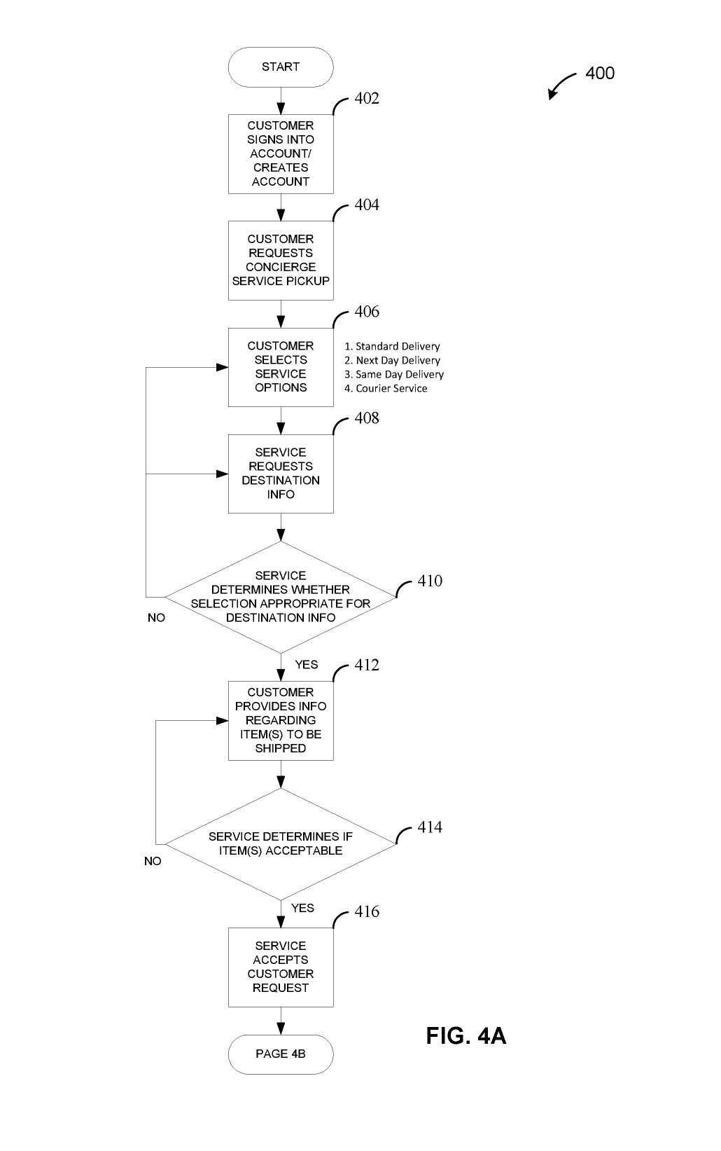

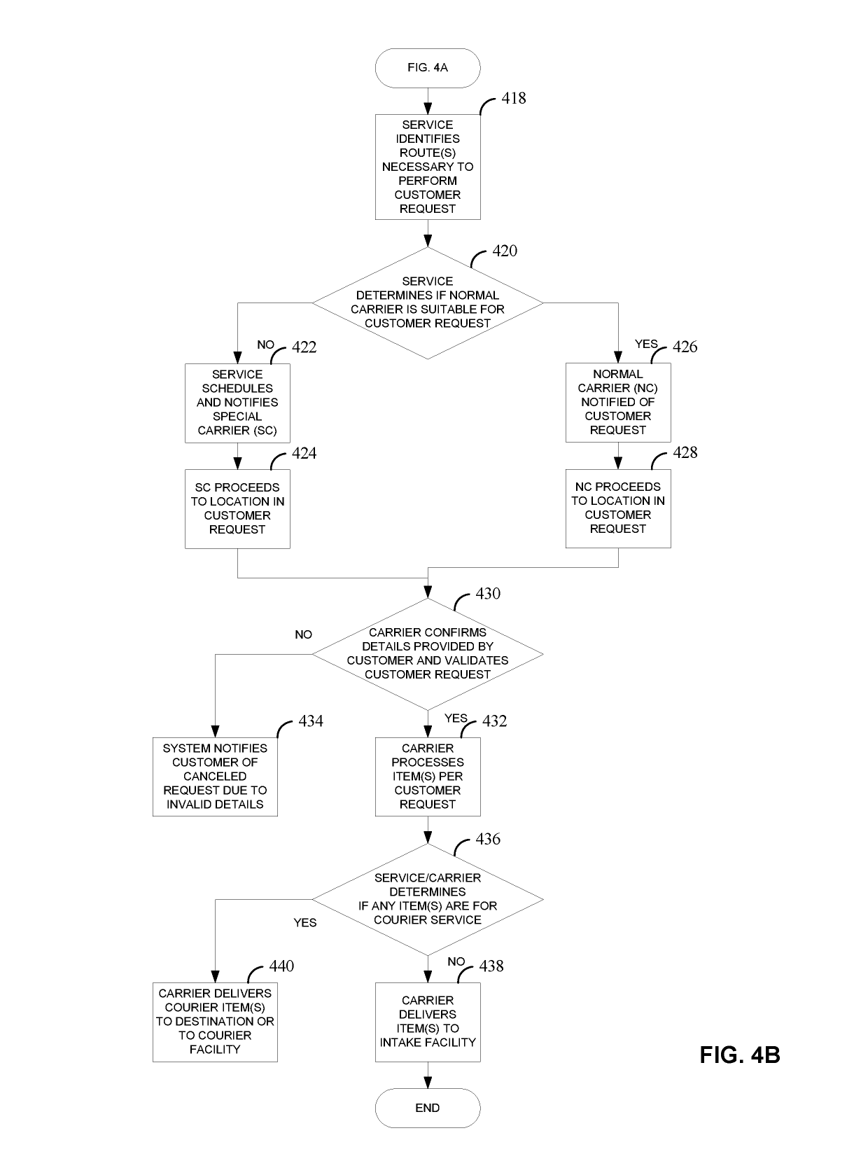

Additionally, the PPS application may provide the carrier with the option to capture additional images of the item being picked-up and packaged for records or for tracking purposes. The image(s) captured may be used to determine needs for special packaging materials or to track the physical parameters of the item, such as condition, damage, etc. In some embodiments, the images may also be used to indicate the time the item was picked up and to show the item was packaged when picked-up by the carrier. In some embodiments, the PPS application may provide details to the carrier that are generated and provided by the customer or the IDS that the carrier uses to deliver the item. For example, this may occur when the PPS request is for courier service that the carrier will handle him/herself, such as, when the destination is along the carrier's route, etc. In some embodiments, the PPS application may provide the carrier with details as to what courier service the packaged item is to be deliver to or where/how the packaged item is to be entered into the distribution stream. Further details of this will be discussed below with reference to FIGS. 4A-4B.

As described above, FIG. 2B depicts an example of a screenshot of a main screen 250 that may be displayed on a customer interface 126. The main screen 250 depicts information for the carrier (e.g., name, phone number, etc.) as well as access to various applications via icons 255a-255m. As shown, more or fewer icons providing access to additional or fewer applications may be included on the main screen 250. Icons 255a-255m may provide access to a “My Account 255a,” “Rewards 255b,” “Call Support 255c,” “Locations 255d,” “Zip Codes 255e,” “Prices 255f,” “Track 255g,” “Pickup 255h,” “Supplies 255i,” “Hold Mail 255j,” “Coupons 255k,” “PPS 255l,” and “Notifications 255m” applications, respectively.

The “My Account 255a” application may provide the customer with the ability to access to view and/or modify his/her account, which may include contact information for use when providing services to the customer. The “Rewards 255b” application may provide the customer with access to their Rewards account, which may track rewards and use of the customer's reward information. The “Call Support 255c” application may allow the customer to call the local or dispatching office of the IDS or a central office with support issues. The “Locations 255d” application may provide the customer with information regarding locations and contact information of offices of the IDS. The “Zip Codes 255e” application may provide the customer with information regarding national Zip Codes, while the “Prices 255f” application may provide the customer with pricing information and the ability to get price estimates. The “Track 255g” application may allow the customer to track an item in the distribution stream, while the “Pickup 255h” application may allow the user to schedule a pickup by a carrier.

The “Supplies 255i” application may allow the customer to order shipping supplies, while the “Hold Mail 255j” application may allow the customer place a request that the IDS hold his/her mail for a defined period of time. The “Coupons 255k” application may allow the customer to access available coupons for services and/or postage. The “Notifications 255l” application may allow the customer to access notifications received from the IDS on the customer interface 126. The “PPS 255m” application may allow the customer to generate, view and/or modify requests associated with the customer's account.

In some embodiments, the customer may have to access the PPS application via the link 255m in order to receive updates of requests for PPS. In some embodiments, the customer may receive updates, alerts and/or notifications on the main screen 250 regarding PPS requests or other services. In some embodiments, any notifications, updates, etc., received by the customer via the customer interface 126 with regards to the PPS (or any other application or service) may be received via communications with the information acquisition module 120 and/or communication module 150.

The PPS 255m application may provide the customer with the ability to create or modify existing PPS requests associated with the customer's account. For example, the customer may create a PPS request and provide the request information (item information, delivery service desired, payment information, etc.) so as to create the PPS request and submit it to the system 100 for route planning and scheduling of the pickup of the item and entry of the item into the distribution stream or courier stream, depending on the delivery service requested. Alternatively, or additionally, the customer may modify an existing PPS request. For example, if the item has been packaged and picked-up, the customer may change the delivery options and pay for any cost different or receive credit for any difference. The customer may also change a destination address. If the item has not been picked-up and packaged, then the customer may adjust specifics of the item itself (such as size, weight, etc.).

In addition to the PPS services described above, the IDS may provide various additional services to customers via the carriers. Examples of these services available to the customer from the carrier may be classified into four broadly defined categories. The first category, Check-in Services, may comprise services that the carrier may provide to alert the customer to status conditions. As shown in FIG. 2A, the Check-In Services 205e may activate an application specific to Check-In services or present/activate a page showing all requests or subscriptions for check-in services. The check-in services may be separated into various subsets. For example, check-in services may include mailbox services or wellness services. The mailbox services may include carrier verification or check-in of mailbox status. The wellness services may include carrier verification or check-in of the resident or resident's property (yard, dwelling, etc.). The mailbox status check-in service may comprise the carrier providing a physical or electronic notification to the customer that a mailbox associated with the customer's address is full, damaged, missing, stuck, etc. The “mailbox” may correspond to any receptacle, slot, container, or other storage or access device used by an item carrier to delivery an item (for example, a slot in a door or a receptacle attached to a dwelling). Accordingly, if the customer is out of town and/or does not regularly visit/see his/her mailbox, the mailbox status check-in may provide the customer with advance knowledge of an issue that may impede his/her ability to receive item.

Alternatively, the carrier may provide wellness services, which may comprise a physical verification of a resident's wellbeing at the residence/location (photographic verification that resident answered door) or may involve a wellness check of the property (photographic verification of no broken windows, status of yard/home, etc.). However, if the resident does not answer the door or the carrier identifies evidence of potential damage to the house (e.g., a broken window), the carrier may request the resident contact the carrier via an alternate means, alert the customer that requested the wellness service (or an emergency contact), and/or alert authorities to a suspicious situation.

A second category may include Carrier Commercial Services. As shown on FIG. 2B, the Carrier Commercial Services 205f may activate an application specific to carrier commercial services or present/activate a page showing all requests or subscriptions for carrier commercial services. These services may comprise situations where the carrier serves as a liaison between the customer and a commercial entity or as a delivery point for the commercial entity for items destined to a specific customer. For example, a customer may request that the carrier pickup and delivery medical supplies and/or prescriptions from a pharmacy (or similar entity) and deliver them to the customer's residence/location. In some embodiments, the Carrier Commercial Services may further include pickup and delivery of gifts, packaging, and/or supplies (for example, office supplies) or to the door delivery of items. Additionally, the Carrier Commercial Services may include carrier disposal services, where the customer may request that the carrier dispose of an item(s) for the customer for a fee.

A third category may include Carrier Concierge Services. As shown on FIG. 2A, the carrier concierge services 205g may activate an application specific to carrier concierge services or present/activate a page showing all requests or subscriptions for carrier concierge services. These services may include pickup, package, and ship services, where the carrier may pick up the item being sent by the customer and package the item him/herself before entering the packaged item into the distribution stream or a courier service. Additionally, the concierge services may include seasonal cleaning/shipping services. Finally, the concierge services may include providing typical IDS office services at the customer's door, for example passport services, license renewals, voter registration, shredding services, etc.

The fourth category, Carrier Ordered Services, may include delivery of necessities that a customer may not have sufficient space to store or provide access to regional goods (e.g., food and beverages) that may not be easily accessible nationwide. As shown on FIG. 2A, the Carrier Ordered Services 205h may activate an application specific to carrier ordered services or present/activate a page showing all requests or subscriptions for carrier ordered services. The Carrier Ordered Services may also include the ability to provide vehicle mounted services, such as, traffic updates or mapping updates for commercial partners, or meter reading for utility companies.

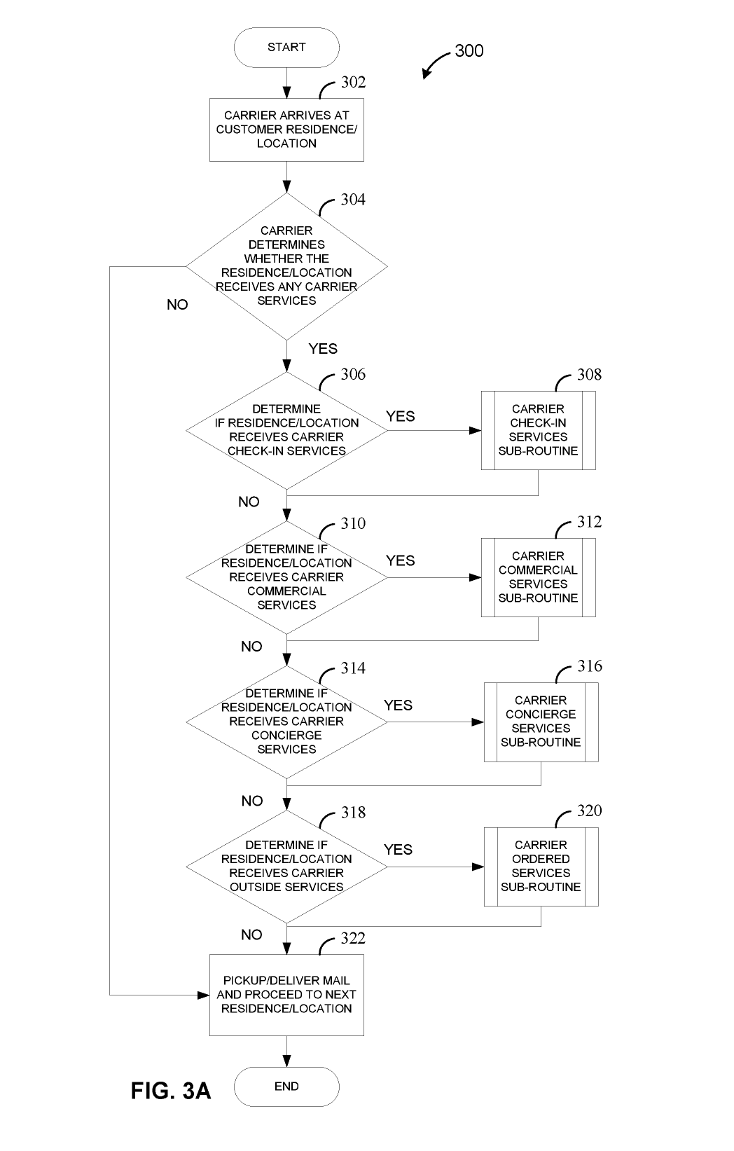

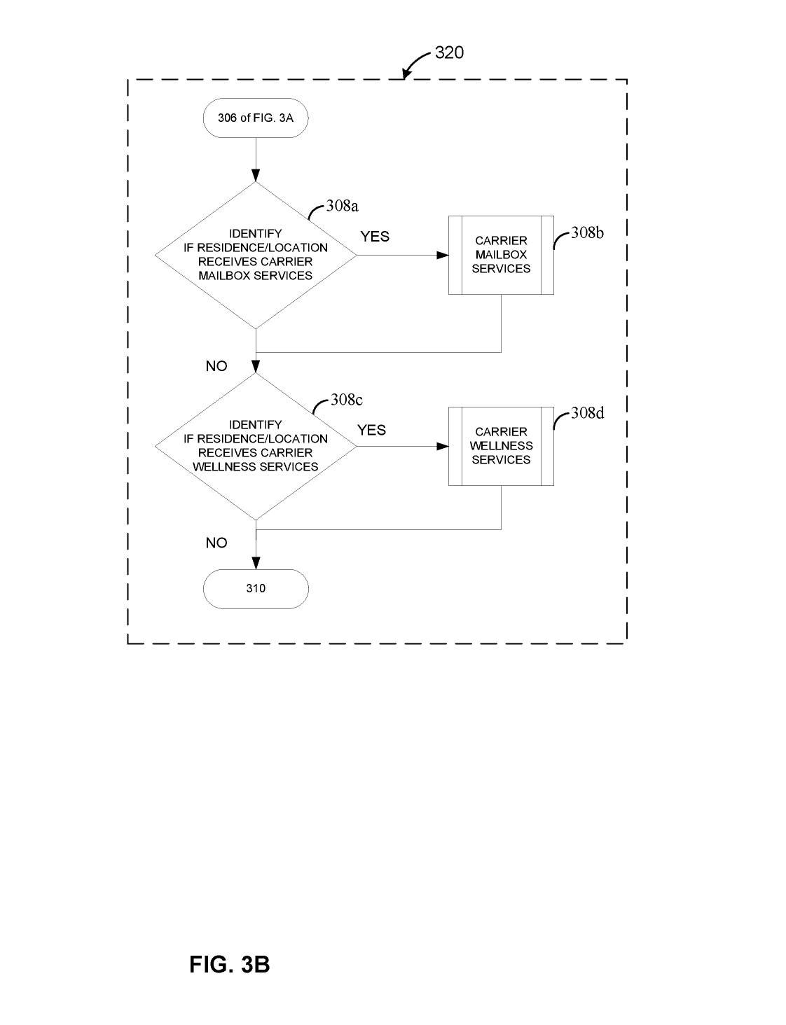

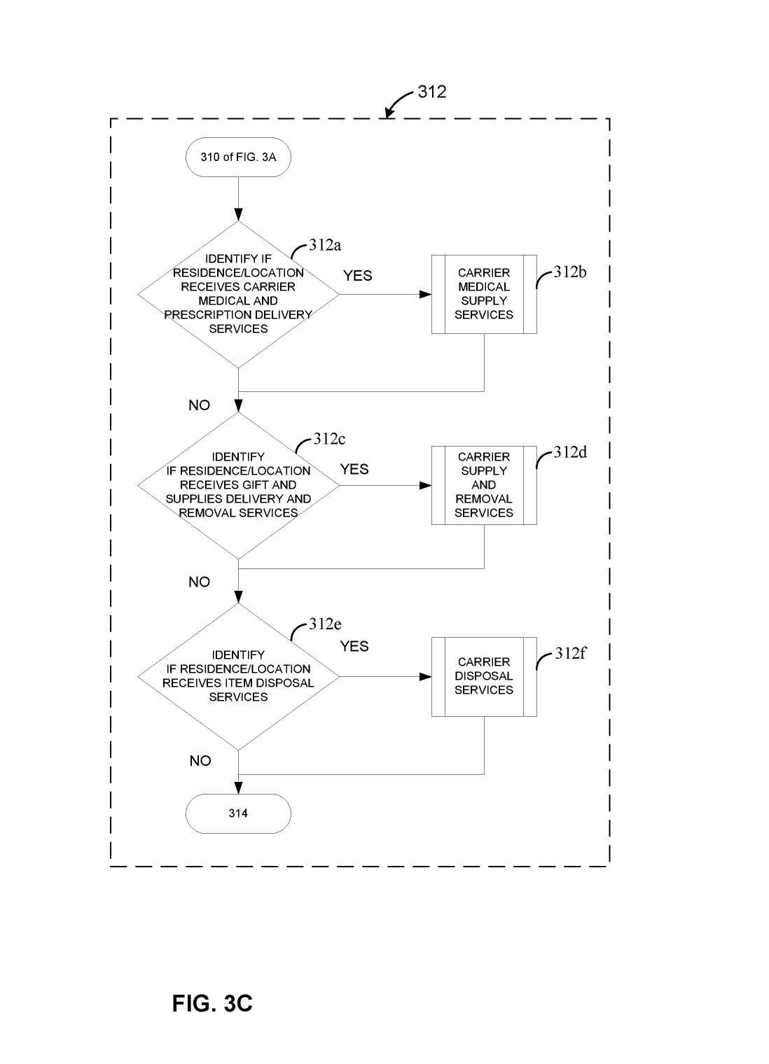

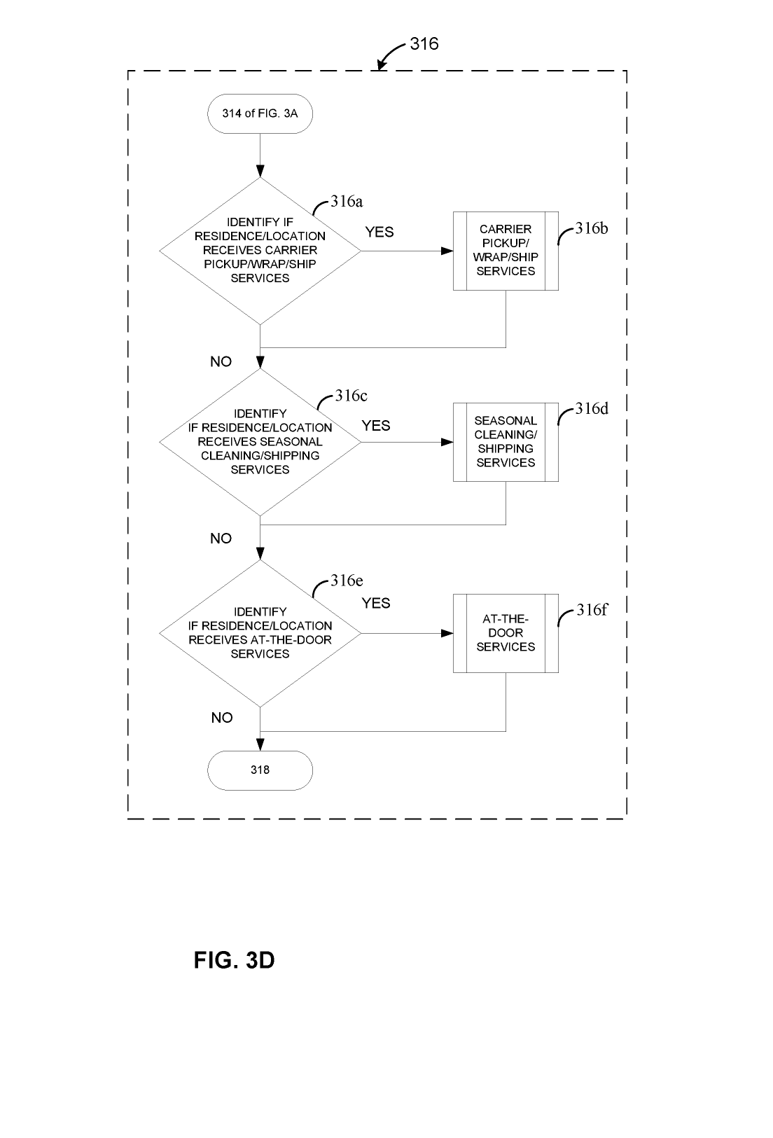

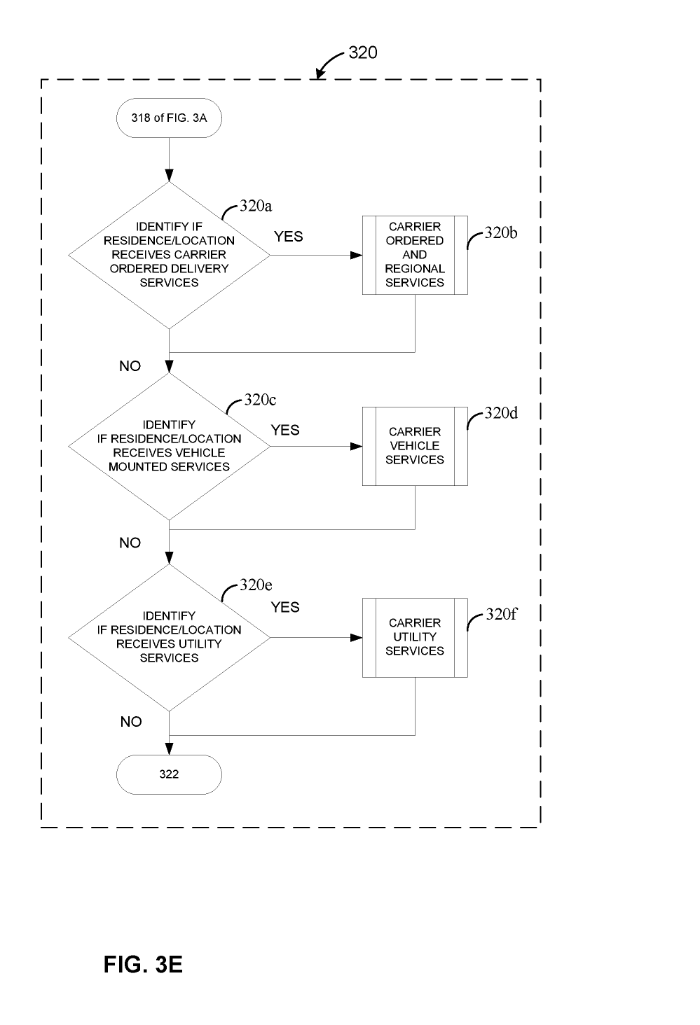

FIG. 3A depicts a flow chart 300 of steps a carrier may perform at a residence with regards to carrier provided services that may be requested by customers and scheduled accordingly via the system 100. The carrier may arrive at the customer's residence or location at step 302. In some embodiments, this arrival and stop at the customer's residence/location may be a normal, everyday occurrence if the carrier operates the route servicing the customer's residence/location. Once the carrier arrives at the customer's residence and location, the carrier determines whether the residence/location receives or subscribes to any carrier services, at step 304. The carrier services may comprise any one or more of Carrier Check-in Services, Carrier Commercial Services, Carrier Concierge Services, and Carrier Ordered Services. Details of services provided that fall under each of these categories will be discussed below. The carrier may determine that the residence/location does receive a carrier service by utilizing his/her mobile computing device 124 to identify what residences/locations receive specific services. In some embodiments, the mobile computing device 124 may generate a list of all residences and locations that receive a carrier service. In some embodiments, the mobile computing device 124 may automatically track the location of the carrier and may provide automatic notifications to the carrier when arriving at a residence/location that receives a carrier service. In some embodiments, the carrier may manually check individual applications for each service to identify open requests.

If, at step 304, the carrier determines that the residence/location does not receive any carrier services, the carrier will proceed to step 322, where, assuming the carrier is the daily carrier for the residence/location, he/she will pick up and deliver item(s) to the residence/location and then proceed to the next residence/location. If the carrier determines that the residence does receive at least one carrier service, then the carrier will proceed to step 306, where the carrier begins determine which carrier service the residence/location receives or subscribes to. At step 306, the carrier determines if the residence/location receives Carrier Check-in Services. If the residence/location does receive Carrier Check-in Services, then the carrier performs the Carrier Check-in Services process at step 308. If the residence does not receive Carrier Check-in Services, then the carrier proceeds to step 310. At step 310, the carrier determines if the residence/location receives Carrier Commercial Services. If the residence/location does receive Carrier Commercial Services, then the carrier performs the Carrier Commercial Services process at step 312. If the residence/location does not receive Carrier Commercial Services, then the carrier proceeds to step 314.

At step 314, the carrier determines if the residence/location receives Carrier Concierge Services. If the residence/location does receive Carrier Concierge Services, then the carrier performs the Carrier Concierge Services process at step 316. If the residence/location does not receive Carrier Concierge Services, then the carrier proceeds to step 318. At step 318, the carrier determines if the residence/location receives Carrier Ordered Services. If the residence/location does receive Carrier Ordered Services, then the carrier performs the Carrier Ordered Services process at step 320. If the residence/location does not receive Carrier Ordered Services, then the carrier proceeds to step 322. Once the carrier has determines which carrier services the residence/location receives and performed the necessary processes according to the determinations, the carrier proceeds to step 322, as described above.

As discussed briefly above, the carrier may provide a variety of services to customers in response to customer requests. The customer requests may be submitted online through a system that associates the request to a customer profile, or the requests may be submitted in person at an IDS office. In some embodiments, when the request is submitted online with a newly created customer profile, the IDS system 100 may decide to schedule an appoint to verify the customer's identity for security purposes.

FIGS. 3B-3E illustrate the actions that the carrier may perform for each of the categories of carrier services described above with reference to FIG. 3A for the Carrier Check-in Services, Carrier Commercial Services, Carrier Concierge Services, and Carrier Ordered Services, respectively. FIG. 3B, regarding the Carrier Check-in Services, may begin at step 308a. At step 308a, the carrier will identify if the residence/location receives carrier mailbox check-in services. If the residence/location does receive carrier mailbox check-in services, then the carrier performs the process of step 308b regarding the carrier mailbox services. If the residence/location does not receive carrier mailbox check-in services, then the carrier proceeds to step 308c. At step 308c, the carrier identifies if the residence/location receives wellness services. If the residence/location does receive carrier wellness services, then the carrier performs the process of step 308d regarding the carrier wellness services. If the residence/location does not receive carrier wellness services, then the carrier proceeds to step 310.

As an example of block 308b, a customer may request the IDS/carrier to monitor the status of the customer's mailbox and provide status updates to the customer and/or a third party as indicated by the customer. For example, the customer may be going on vacation and may request that the IDS provide any indications of a condition of the mailbox that may impede delivery of items to the customer. For example, the IDS carrier may monitor the mailbox and provide a notification if the mailbox is full, if the mailbox contains a perishable item or if the mailbox is damages, broken, missing, or not lockable/sealable. Accordingly, the carrier may indicate the status of the mailbox on his/her mobile computing device 124, and if certain threshold values are met (e.g., if the delivery of item(s) is impeded), the system 100 may receive the status indication from the mobile computing device 124. In response to the status indication exceeding the threshold level, the system 100 may send a notification via the communication module 150 to the customer and to any third parties indicated by the customer (such as a neighbor with authority to empty the mailbox or perform necessary maintenance on the mailbox). In some embodiments, the customer that makes the request may not live at the residence/location, but rather may have a financial stake in the residence/location. For example, a property owner that is renting out a house may request mailbox services in order to help the property owner maintain awareness of the conditions of his property. However, instead of requesting notification if the mailbox is simply full, the property owner may only care when the mailbox is damaged or missing and may request to be notified only in such conditions.

Alternatively, or additionally, as an example of block 308d, the customer may request a wellness check-in. The wellness check-in may include wellness of the property associated with a specific address or may include wellness of one or more residents or occupants of the residence/location. For example, the customer may request the IDS monitor the property associated with the address (the residence/location). Accordingly, the customer may request photographic updates, where the carrier will provide photos of the property to the customer, or text only updates, where the carrier may provide text descriptions of the property without any photos. If the carrier identifies suspicious conditions (e.g., a broken window or missing item, then the customer may request the carrier send a notification to the customer and also alert a security company or the police department, or some other third party. Such monitoring may be requested by an owner/occupant when the owner/occupant is traveling or when the property is a vacation or weekend home. As discussed above, the customer that requests the property wellness check-in may not reside or be located at the residence/location, but may instead be a property owner or otherwise associated with the property being checked up on. In some embodiments, the customer may receive the check-in communication from the carrier but notice an irregularity from the photo or text description. Accordingly, the customer may request the IDS and/or the carrier directly to verify the irregularity and/or notify authorities, etc.

In some embodiments, geofencing may be used by the carrier and/or IDS to notify the carrier when the carrier is in the vicinity of a customer and/or residence that have requested a check-in service. For example, the carrier may receive a notification on the carrier's mobile carrier device (i.e., mobile carrier device 124) when the carrier is within a certain geographical distance from the customer or location to which the check-in service request applies. Alternatively, or additionally, when the carrier delivers an item to a particular location or customer, the carrier's mobile carrier device may present a notification regarding a check-in request for the current location or carrier or a nearby location or carrier. Once the carrier performs the requested check-in service, the notification may be automatically cleared.

In some embodiments, the customer may request a wellness check-up of a resident living at the residence/location. These wellness checkups may be in person visual and/or verbal verification of wellbeing of the resident. In some embodiments, the customer may request that the carrier send a picture or recording or other proof of the wellbeing verification. In such embodiments, the customer may not be a resident of the residence/location but rather a relative of the resident or person at the residence/location, for example a child checking up on an elderly parent, or a parent check in on a baby sitter. In some embodiments, the wellness-check-up may be associated with other services. For example, the carrier may be requested to perform mailbox check-ins and may indicate that mail accumulates over a period of successive days (for example, on each of a series of days, the carrier may indicate that mail has not been collected by the customer at a given location). The IDS may track the number of days over which mail has not been collected by the customer and determine that there may be an issue or cause for concern. Such indications by the carrier may be made via the carrier's mobile carrier device.

FIG. 3C, regarding the Carrier Commercial Services, may begin at step 312a. At step 312a, the carrier may identify if the residence/location receives carrier medical and prescription delivery services. As described above, the carrier's mobile carrier device may indicate or otherwise notify the carrier that the carrier is at or near a location or customer that receives carrier commercial services. For example, the IDS may maintain a database of carrier commercial service requests, and the IDS may, in conjunction with tracking the locations of associated carriers, send a notification or other alert to specific carriers that are near or at a location or customer that has requested a carrier commercial service. The carrier medical and prescription services may involve the carrier picking up prescription and other medical supplies for the customer.

In some embodiments, the customer request for the carrier services may involve identification or verification steps. For example, if the customer is requesting the carrier pickup prescriptions or other controlled substances, the request may require the customer to prove his/her identity and to explicitly give permission to the IDS and its carriers to collect and gather his/her prescriptions. In some embodiments, the identification and/or verification steps may be performed when the customer generates the request for carrier pickup services, which, in the case of prescriptions or other confidential or otherwise controlled or valuable items, may need to be requested in person either at an IDS location or in person with the carrier of the IDS. For example, the customer requesting the carrier pickup prescriptions may proceed to a local IDS office to generate the request, where a worker at the IDS office can verify the identity of the customer. Alternatively, the customer may make the request online but the IDS may have a carrier visit the customer in person to verify the customer's identify before having a carrier perform the requested pickup service.

In some embodiments, if the customer is not requesting the IDS carrier deliver prescriptions or controlled substances, then the request may not have as stringent requirements. Additionally, delivery of controlled substances may require the IDS system 100 to be more involved in the scheduling and route planning of the prescription and medical supply delivery. For example, when the delivery includes prescriptions or controlled substances or other medical supplies that are monitored in their distribution, the dynamic router 130 may be involved in scheduling and planning routes using carriers that are permitted to handle such supplies and substances. In some embodiments, only a limited number of carriers may be permitted and/or authorized for such work, the dynamic router 130 may schedule prescription and medical supply carriers based on priorities of customer requests, locations of the pharmacies, customers, and qualified, permitted carriers, and carrier availability. In some embodiments, the carrier medical supply services may also assist in the removal of used supplies. In some embodiments, depending on the items being delivered by the carrier, the carrier may deliver the medical supplies to the customer's mailbox or the prescriptions to the customer's door.

Once the carrier medical supply services are complete, or if there are no medical and prescription delivery services requested, the carrier may proceed to step 312c. At step 312c, the carrier may identify, via an alert or other notification on the carrier's mobile carrier device, if the residence/location receives gift and supplies delivery and removal service. As discussed above, such alerts or notifications may be based on geofencing or other location based methods. For example, the customer may request or may have previously requested that the IDS/carrier pickup and deliver gifts, packaging supplies, and remove extra or waste supplies.

Alternatively, or additionally, the supply and removal services may include delivery of items (gifts/supplies) and removal of items (waste, etc.) at the residence/location door as opposed to only at the mailbox. Such “door” service may facilitate human contact and help ensure that packages and deliveries make it to the recipient. In some embodiments, the carrier may provide photographic evidence of delivery of the item/gift or the supplies to the sender and/or the customer, respectively. Additionally, or alternatively, the Carrier Commercial Services may include an option that any item delivered to the residence/location is delivered to the door as opposed to the mailbox. In some embodiments, this option may be included in any other Carrier Service category. If the carrier determines (for example, via the geofencing or similar methods described above) that the residence/location does receive Carrier Supply and Removal Services, then the carrier performs the process of step 312d.

In some embodiments, the Carrier Supply and Removal Services of step 312d may involve the carrier acting as a delivery service for any goods/services that may be along the carrier's route. For example, if the carrier services or passes by a dry cleaner that the customer uses, then the carrier may be requested to pick up and deliver the customer's dry cleaning. The dynamic router 130 of the system 100 may be utilized to help generate a route and schedule for any pickups/deliveries that are not along the carrier's typical route or to inform the carrier that he/she will have a pickup and/or delivery at a particular commercial business or customer residence/location. Thus, in some embodiments, the customer request may need to be made a threshold time in advance of the desired service time (e.g., delivery time or pickup time) so that the dynamic router 130 has sufficient time to generate a route and schedule incorporating the requested stops.

Once the process of step 312d is complete or if the carrier identifies (via geofencing or similar methods via the carrier's mobile carrier device) that the residence/location does not receive supply and removal services, then the carrier proceeds to step 312e, where he/she identifies if the residence/location receives item disposal services. If the residence/location does receive item disposal services, then the carrier performs the process of step 312f regarding Carrier Disposal Services. In some embodiments, the Carrier Disposal Services will assist the customer with disposal of hard to dispose of items, such as electronic goods, batteries, motor oil, appliances, etc. In some embodiments, the dynamic router 130 may identify customer disposal requests that need special equipment or trucks, for example disposal of appliances containing refrigerant (air conditioners, refrigerators, etc.).

Accordingly, the dynamic router 130 may identify and schedule resources for the disposal request according to the item to be disposed of and the ability for a specific carrier to assist in the disposal. For example, the carrier may be able to collect used batteries (e.g., AAA, AA, C, D, etc.) or small electronic devices (e.g., phones, tablets, etc.) and may be able to collect hard drives for safe clearing/destruction and disposal. Once the carrier completes the Carrier Disposal Services at step 312f, or if the carrier identifies that the residence/location does not receive Disposal Services, then the carrier may proceed to step 314 of FIG. 3A.

FIG. 3D, regarding the Carrier Concierge Services, may begin at step 316a. At step 316a, the carrier may identify (via geofencing or similar methods via the carrier's mobile carrier device) if the residence/location receives carrier concierge services, including the carrier pickup and package services (PPS). If the residence/location receives carrier PPS, then the carrier may proceed to step 316b and perform the process associated with the FIGS. 4A and 4B described below. Once the carrier performs the process associated with FIGS. 4A and 4B, or if the residence/location does not receive PPS, then the carrier may proceed to step 316c. At step 316c, the carrier may identify if the residence/location receives seasonal cleaning/shipping services. If the residence/location does receive seasonal cleaning/shipping services, then the carrier may perform the process associated with step 316d. The seasonal cleaning/shipping services may involve allowing the customer to order cleaning materials and boxes for delivery by a set date for seasonal cleaning, where the supplies and boxes will be used by the customer to perform cleaning and the carrier and the IDS may assist the customer by collecting and disposing of the items as requested by the customer. Once the carrier performs the process associated with the seasonal cleaning/shipping service, or if the carrier identifies that the residence/location does not receive the seasonal cleaning/shipping service, then the carrier will proceed to step 316e.

At step 316e, the carrier will identify (via geofencing or similar methods via the carrier's mobile carrier device) if the residence/location receives at-the-door services, and, if it does, the carrier will perform the process associated with step 316f. At-the-door services may involve the providing any services the customer may obtain from a physical IDS office location at the customer's residence/location. For example, where the customer may go to a physical IDS office to obtain passport services, the carrier may provide passport services at the customer's residence/location. Similarly, any other services available at the physical IDS office (for example, purchase of stamps, packaging, money orders, licenses, voter registration, etc.) may be available from the carrier. Additionally, services such as certified or registered item or secure document transmittals may be available from the carrier as part of the “at-the-door” services.

In some embodiments, common business forms may be available from the carrier at the customer's door, for example tax return documents, etc. In some embodiments, notary services may be available from the carrier, as the carrier will be able to authenticate a customer during the visit. Alternatively, the at-the-door services may include shredding services, where the carrier may pick up items to be shredded at another site or may provide shredding services in the carrier's vehicle. Once the “at-the-door” services are completed, or if the carrier identifies that no at-the-door services are requested by the customer, then the carrier proceeds to step 318 of FIG. 3A.

FIG. 3E, regarding the Carrier Concierge Services, may begin at step 320a. At step 320a, the carrier may identify (via geofencing or similar methods via the carrier's mobile carrier device) if the residence/location receives carrier ordered delivery services. If the residence/location does receive carrier ordered delivery services, then the carrier will perform the process associated with step 320b. The carrier ordered and regional services of step 320b may provide the ability for the customer to order and receive necessities required for one-time projects and/or household or location management. In some embodiments, such deliveries may be provided for locations lacking space to store the necessities or to ease cost of storage and pre-purchase.

Additionally, or alternatively, the carrier ordered and regional services may facilitate the ability for a customer to obtain regional items, for example a food or beverage or other good that may be available in a specific region of the country or state and that is not readily available in the customer's region. As the IDS may be performing services in the region where the food, beverage, or other good is available, the IDS may be in a unique position to obtain the food, beverage, or other good and provide it to the customer at a lower cost than may otherwise be available. Once the carrier completes the carrier ordered and regional services of step 320b, or identifies that the residence does not receive these services, the carrier proceeds to step 320c.

At step 320c, the carrier determines (via geofencing or similar methods shown on the carrier's mobile carrier device) if the residence/location receives vehicle mounted services. If the carrier determines that the residence/location receive vehicle mounted services, then the carrier performs the process associated with step 320d. In some embodiments, the process associated with step 320d may involve activating a component of the carrier's vehicle or equipment that is carried by the carrier to provide the carrier vehicle services. In some embodiments, the carrier vehicle services may include traffic monitoring/real-time updates and/or route tracking/planning or street-view mapping/monitoring. Alternatively, or additionally, the carrier vehicle services may include identification of traffic incidents or construction areas or short/long-term developments that may influence traffic patterns. In some embodiments, the carrier vehicle services may include monitoring of weather conditions or environmental conditions, which may be provided to third parties. Once the carrier completes the process(es) associated with step 320d, or if the carrier determines that no carrier vehicle services are received by the residence/location, the carrier may proceed to step 320e.

At step 320e, the carrier may identify on the carrier's mobile carrier device via geofencing or similar methods, if the residence/location receives utility services. If the residence/location does receive utility services, then the carrier performs the process associated with step 320f. The process associated with step 320f may include a variety of services that may be useful for local utility companies (or similar third parties). For example, the IDS carrier vehicles can travel an extensive portion of a geographic area, and can provide meter reading services to a local utility. For example, the local water or electric company may have meters (often installed in residences or other buildings) that are capable of wirelessly communicating with “reader” devices such that information from the meters pertaining to meter values may be communicated to the reader.

In some embodiments, the IDS carrier vehicle(s) have the “reader” devices mounted on them, then the IDS carrier vehicle can gather the information from the meters during the normal conduct of item delivery routes, etc. In such embodiments, the IDS carrier vehicles and carriers may facilitate acquisition of census data or other neighborhood data which may be provided to the local governmental organizations. Once the carrier utility services have been performed, or if the carrier determines that the residence/location does not receive utility services, then the carrier proceeds to step 322 of FIG. 3A.

FIGS. 4A and 4B depict an exemplary method 400 for receiving, scheduling, and performing a concierge service by a carrier as requested by a customer. The method 400 may involve multiple blocks/steps performed by a customer and received by the system 100 or commanded by the system 100 for the carrier to perform. In some embodiments, various components of the system 100 may perform the associated blocks/steps of the method 400. For example, the central processor 110, the memory 115, the information acquisition 120, or the dynamic router 130 may interface with one or more mobile computing devices 124, customer interfaces 126, commercial interfaces 128, and item processing equipment 122 during the method 400. In some embodiments, more, or fewer, components of the system 100 depicted in FIG. 1 may participate in the method 400.

The method 400 may begin at block 402, where the method 400 comprising identifying, via the central processor 110 or the customer interface 126, the customer signing into an account or creating an account with the IDS. The customer account may comprise contact information (e.g., address, phone number, etc.), payment information, and/or service preferences associated with one or more customers or residences/locations. The customer account may allow both the customer and the IDS to monitor and modify the customer requests and act on the customer requests as needed. For example, the customer account may allow the customer to enter a default delivery address, such that when the customer schedules delivery of shipping supplies ordered from the IDS, the IDS may use the default delivery address from the customer account as the destination address form the requested shipping supplies.

In some embodiments, the customer may create or sign into the customer account using the customer interface 126 (for example, the customer's cell phone, computer, or a terminal at an IDS office, etc.). In some embodiments (though not shown in this figure), if the customer creates a new account at block 402, then the method 400 may proceed to a block where the new account may be verified using in person verification methods (via a carrier with the mobile carrier device 124 or via a carrier at a location IDS office) before services are performed that are associated with the newly created account. However, alternatively, or additionally, once the customer signs into or creates an account at block 402, the method 400 may proceed to block 404. At block 404, the method 400 may comprise receiving a request for a concierge service pickup from a customer. Once the concierge service pickup is requested, the method 400 proceeds to block 406.

At block 406, the method 400 comprises receiving, via the communication module 150, the customer interface 126, or the information acquisition module 120, a customer selection of one or more service options that are associated with the requested concierge service pickup. For example, these service options may include delivery options, such as standard delivery, next day delivery, same day delivery, or dedicated courier service. Each of the delivery options may dictate how the carrier handles the item being picked up. For example, items picked up for standard delivery may be entered into a standard distribution stream, while items pickup up for next day delivery may be entered into a next day delivery distribution stream. Similarly, items picked up with the same day delivery option may be entered into a same day delivery distribution stream, and items picked up for courier services may be entered into a courier system.

In some embodiments, selection of service options at block 406 may include selecting one or more other options that may impact the concierge service, such as scheduled pickup date, etc. Once the services options associated with the concierge service pickup are selected at block 406, the method 400 proceeds to block 408. At block 408, the method comprises requesting and receiving destination information from the customer, for example via the customer interface or the communication module 150 or from the memory 115, after which the method 400 proceeds to block 410.

At block 410, the method 400 comprises determining, via the central processor 110, whether the selected option(s) from block 406 is appropriate for the destination information provided at block 408. For example, if the customer requested same day delivery for a destination that is in another country, then the method 400, via central processor 110, may identify that the selected service is improper for the desired destination, and may return to block 406 and/or block 408 to request either selection of different service options or different destination information, respectively. If the method 400 determines at block 410 that the service option selected at block 406 is appropriate for the destination information provided, then the method 400 proceeds to block 412. At block 412, the method 400 comprises providing the system 100, via customer interface 126 or communication module 150, information regarding the item(s) to be shipped. Once the customer provides information regarding the item(s) to be shipped, the method 400 proceeds to block 414.

At block 414, the method 400 comprises determining, via the central processor 110 from the information regarding the item(s) to be shipped, if the item(s) are acceptable for shipment by the method 400. If the item(s) is determined to not be acceptable, then the method proceeds back to block 412, where information for the item(s) to be shipped is again requested. If, at block 414, the service determines the item(s) are acceptable, then the method 400 proceeds to block 416. At block 416, the method 400 comprises accepting the customer's request via the customer interface 126 or the communication module 150 or the central processor 110. In some embodiments, the acceptance of the customer's request may be indicated to the customer. Once the request is accepted at block 416, the method 400 proceeds to block 418.

At block 418, the method 400 may comprise identifying, via the central processor 110 or the dynamic router 130, route(s) that may be affected by or may be required to perform the customer request. For example, if the customer request is received after the daily scheduled (normal) carrier has serviced the customer's pickup location, then the normal carrier's route and/or schedule may be modified to include the newly received request. In some embodiments, this route/schedule modification may be performed by the dynamic router 130 or the central processor 110. In some embodiments, the dynamic router 130 or central processor 110 may be configured to modify one or more carrier routes to accommodate late received customer requests. In some embodiments, the dynamic router 130 or the central processor 110 may schedule a special carrier (a carrier that does not normally service a particular customer) to perform the concierge pickup. In some embodiments, some customer requests may be accepted for service (for example, pickup) on a specific day based on a priority indicator given to a particular customer.

For example, a high volume customer may be given priority over a low volume customer. In an example embodiment, if the high volume customer and the low volume customer both submit a request for the concierge pickup service after their daily carrier has serviced their location, and the dynamic router 130 determines that only one of the two customer requests can be serviced on the same day, then the dynamic router 130 may schedule the pickup for the high volume customer and decline the request from the low volume customer. In some embodiments, the prices for the services may fluctuate based on the volume of items provided for transportation through the IDS, where higher volumes may receive reduced prices. After the route(s) are identified at block 418, the method 400 proceeds to block 420.

At block 420, the method 400 comprises determining, via the central processor 110 or the dynamic router 130, if the normal carrier is suitable for the customer request, based on the information from block 418. If the method 400 determines that the normal carrier is suitable for the customer request (for example, the normal carrier either has not yet serviced the pickup location or is able to circle back to the already serviced pickup location), then the method 400 proceeds to block 426. If the method 400 determines that the normal carrier is not suitable for the customer request (for example, the normal carrier has already serviced the pickup location and is unable to circle back based on pending scheduled requests), then the method 400 may proceed to block 422.

At block 422, the method 400 comprises scheduling and notifying a special carrier, via the central processor 110, the dynamic router 130, or the communication module 150, (for example, a carrier whose route did service the pickup location) to perform the requested concierge pickup service. In some embodiments, scheduling the special carrier may comprise dispatching an inactive carrier (for example, a carrier that is not currently servicing any routes). Alternatively, or additionally, scheduling the special carrier may comprise adding the pickup request to a special carrier that is already servicing one or more other customer requests. Once the method 400 schedules and notifies a special carrier at block 422, the method 400 proceeds to block 424, where the method 400 comprises directing the special carrier to the location indicated by the customer request, via the mobile computing device 124 (for example, the mobile carrier device) or the communication module 150, and the special carrier proceeds to said location. Once the special carrier arrives at the specified location, the method 400 proceeds to block 430.

At block 426, the method 400 comprises scheduling and notifying the normal carrier (for example, the carrier whose route services or serviced the pickup location for that particular day) to perform the requested concierge pickup service via the communication module 150, the dynamic router 130, or the mobile computing device 124. In some embodiments, scheduling the normal carrier may comprise adding the pickup request to the normal carrier's schedule and route. In some embodiments, where the normal carrier has not already serviced the pickup location, then the method 400 (for example via dynamic router 130) may add the pickup request to the carrier's schedule. In some embodiments where the normal carrier has already serviced the pickup location, then the method 400 may modify the carrier's route to reroute the carrier back to the pickup location that has already been serviced.

After the method 400 schedules and notifies the normal carrier at block 426, the method 400 proceeds to block 428, where the method 400 comprises directing, via the central processor 110, the mobile computing device 124, the dynamic router 130, or the communication module 150, the normal carrier to the location indicated by the customer request via the communication module 150, the dynamic router 130, or the mobile computing device 124, and the normal carrier proceeds to said location. Once the normal carrier arrives at the specified location, the method 400 proceeds to block 430.

At block 430, the method 400 comprises determining, via the central processor 110 or the information acquisition module 120, whether it receives confirmation from the carrier (either the normal carrier or the special carrier) of the details provided by the customer regarding the pickup request. For example, when the carrier arrives at the pickup location, the carrier may verify if the details the customer provided (for example, the size, shape, contents, etc.) of the item match the physical item that is available for the carrier's pickup. If the details do match, then the carrier indicates the fact that the details provided by the customer to match the physical item, and the method proceeds to block 432. If the details do not match, then the carrier indicates that and the method proceeds to block 434. In some embodiments, it may be important for the details provided by the customer regarding the item for concierge pickup to match the physical details of the item as verified by the carrier so that the carrier can ensure to have the proper materials for packaging and shipment of the item. Alternatively, or additionally, the details must match so that the carrier can ensure that the item is something the carrier and/or the IDS is capable of shipping (for example, the item is not something unsafe or illegal to transport).

At block 434, the method 400 may comprises notifying the customer, via the customer interface 126 or the communication module 150, that the concierge pickup request has been canceled or rescheduled with a request for additional information for the customer. For example, if the physical dimensions or some other physical aspect of the item was not described correctly, such that the carrier had insufficient or improper materials to package the item, the system 100 may request updated information regarding the item from the customer with a reschedule date for pickup. Alternatively, or additionally, the notification of the cancelation or rescheduling may include an indication of the reason the pickup request was canceled (for example, improper/incorrect physical details, unsafe for transportation by the selected option, illegal for transportation by IDS or to requested destination, insufficient payment for actual weight/details of item, etc.). If the customer request is rescheduled, then the block 434 may return to a previous block of the method 400 where the customer provides details of the item (for example, block 412 or block 408), not shown in this figure. Alternatively, if the system 100 cancels the customer request, then the method 400 ends after block 434.

At block 432, method 400 comprises processing the item(s) per the customer requests and enters details of the shipping information (for example, identifying bar codes, electronic information, etc.) into the system 100 (via the mobile computing device 124) for tracking, identifying, etc., purposes. In some embodiments, processing the items by the carrier may comprise packaging the item(s) such that they are safely transportable from the pickup location to the destination location. Once the item(s) are processed by the carrier, the method 400 proceeds to block 436.

At block 436, the method 400 comprises determining, via the central processor 110 or the item processing equipment 122, if any item(s) request courier service. In some embodiments, this determination may be made for one or more of the item(s) the carrier is transporting regardless of coming from one or more customer requests. If one or more of the item(s) the carrier is transporting does require courier service (per the customer request), then the method proceeds to block 440, where the carrier delivers those items to a courier facility. Alternatively, at block 438, the method 400 routes the carrier to an item intake facility, where the carrier delivers the item(s) for handling by the IDS distribution equipment.

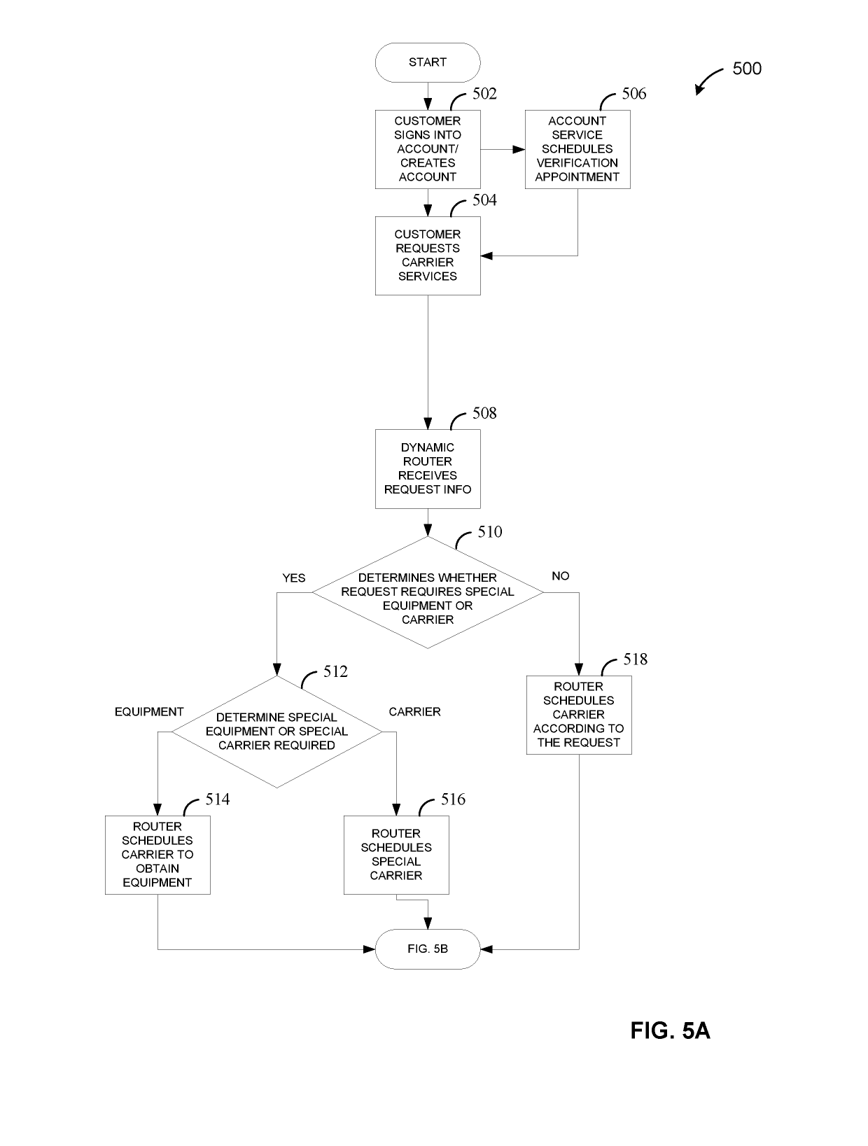

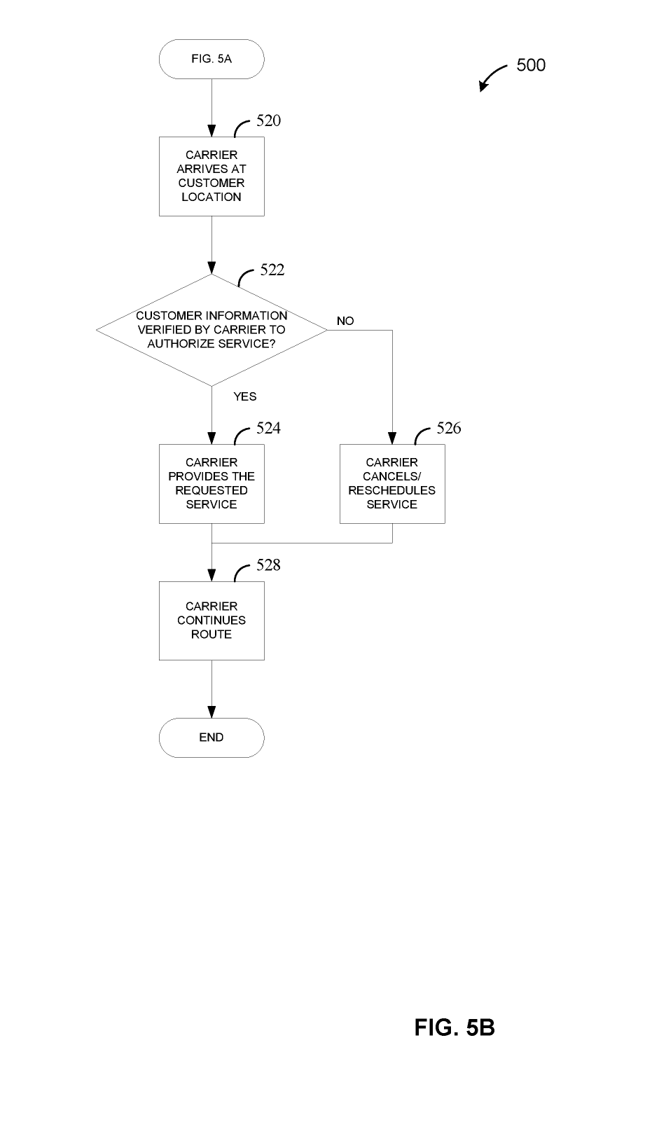

FIGS. 5A and 5B depict a method 500 for scheduling and performing a service by a carrier as requested by a customer. The method 500 may involve multiple blocks/steps performed and received by the system 100. In some embodiments, various components of the system 100 may perform the associated blocks/steps of the method 500. For example, the central processor 110, the memory 115, the information acquisition 120, or the dynamic router 130 may interface with one or more mobile computing devices 124, customer interfaces 126, and item processing equipment 122 during the method 500. In some embodiments, more, or fewer, components of the system 100 depicted in FIG. 1 may participate in the method 500.

The method 500 may begin at block 502, with the method 500 comprising identifying, via the central processor 110 or the information acquisition module 120 or the communication module 150, that a customer signs into an account or creates an account with the IDS. The customer account may comprise contact information (e.g., address, phone number, etc.), payment information, and/or service preferences associated with one or more customers or residences/locations. The customer account may allow both the customer and the IDS to monitor and modify the customer requests and act on the customer requests as needed. For example, the customer account may allow the customer to enter a default delivery address, such that when the customer schedules delivery of shipping supplies ordered from the IDS, the IDS may use the default delivery address from the customer account as the destination address form the requested shipping supplies. In some embodiments, the customer may create or sign into the customer account using the customer interface 126 (for example, the customer's cell phone, computer, or a terminal at an IDS office, etc.). If the customer creates a new account at block 502, then the method 500 may proceed to block 506.

At block 506, the method 500 (for example, via the information acquisition module 120 or the central processor 110) may comprise determining a need to verify the customer account and may schedule a verification appointment. In some embodiments, the scheduling of the verification appointment may be performed by the dynamic router 130. In some embodiments, the method 500 may comprise determining that the customer's account should be verified.

For example, if the customer creates a new customer account and associates the customer account with a service or action that may be considered as requiring a threshold level of security (for example, the customer associates the customer account with a credit card, or requests a specific governmental service, etc.). Once the verification appointment is scheduled at block 506, the verification may be performed before the customer is able to request a carrier service using the newly created customer account. Additionally, or alternatively, the verification of the customer account may occur when the carrier performs the requested service (for example when the carrier performs the requested governmental service or when the carrier delivers something ordered with a credit card on a newly created customer account).

In some embodiments, at block 506, the method 500 may comprise analyzing, via the central processor 110 or the information acquisition module 120, the newly created account. If the newly created account uses the same customer information with different payment information than another account associated with the same customer information, then the block 506 may identify the customer account as needing to be verified. For example, if John Doe creates a new customer account using the same contact information as an existing customer account but adds a new credit card to the new customer account that does not exist in the existing customer account, the new customer account may be determined as needing verification. Accordingly, the system 100 of the IDS may work to minimize potential fraudulent customer accounts.

Once the newly created customer account is analyzed at block 506, or if the customer merely signs into an existing customer account at block 502, the method 500 proceeds to block 504. At block 504, the method 500 comprises the customer requesting a carrier service from or by the customer account. The customer request may be performed via one or more customer interfaces 126. In some embodiments, the block 504 comprises the customer selecting a service as described above in relation to FIGS. 3A-3E (for example, at least one of a carrier check-in service, a carrier commercial service, a carrier concierge service, and a carrier ordered service). The block 504 may comprise the customer entering all the information associated with the request, depending on the service being scheduled. In some embodiments, the request for a service may include dates, specifics of services requested, etc. Once the customer completes the carrier service request, the method 500 proceeds to block 508.

At block 508, the system 100 receives the customer request, specifically at the dynamic router 130 or the communication module 150 or the central processor 110 or the customer interface 126. The receipt of the customer request at the dynamic router 130 may occur via communications with the customer interface 126 via the information acquisition module 120 and/or the central processor 110. In some embodiments, the customer requests may be stored in the memory 115 in a queue until the dynamic router is able to process them or until the system 100 much act on the request in order to complete it as requested by the customer (for example when the service is requested for a future date, etc.). Once the dynamic router 130 receives the request information, the method 500 proceeds to block 510.

At block 510, the method 500, via the dynamic router 130 or the central processor 110, may determine whether the customer request requires special equipment or a different carrier than that which typically services the route and/or schedule on which the customer is located. For example, some of the carrier services that may be requested by the customer may require special equipment that is not used by all carriers of the IDS (e.g., a shredder and/or a passport camera). Alternatively, or additionally, the customer request may require the carrier that typically services the route and/or schedule to which the customer belongs to vary his/her route and/or schedule. The dynamic router 130 or central processor 110 may review the customer request together with all other customer requests with which the dynamic router 130 is associated (for example, all customer requests that are handled by the system 100 (e.g., the customer requests within a geographic area or serviced by a distribution facility having the system 100 therein)). Based on all of the customer requests that the dynamic router 130 or central processor 110 reviews, the dynamic router 130 may generate a schedule and/or route for one or more carriers to perform. In some embodiments, the generated schedule for the carrier may comprise the same route with customer requests added to the carrier's schedule. For example, when the customer requests the carrier pickup and package services, the carrier may be able to maintain his/her typical route, but may have to spend additional time at the customer's residence/location, thus affecting his/her schedule.

Alternatively, the dynamic router 130 may generate a new route and a new schedule for a given carrier. For example, the customer may request the carrier pickup medication or medical supplies from a local pharmacy and deliver them to the customer. Accordingly, the dynamic router 130 may generate the carrier's route adjusted to travel to the pharmacy and the schedule may be adjusted to account for the time needed to travel to the pharmacy, pick up the medication, and deliver the medication to the customer.

In some embodiments, the different carrier services available for request by the customers may be associated with specific equipment or special carriers. For example, the shredding carrier service may require the carrier to have a shredder on his/her truck when the service is to be performed/completed, or the passport services may require a camera and computer system that interfaces with an IDS passport service system. The dynamic router 130 may be configured to appropriately schedule the carriers with the special equipment such that requested services are performed by the requested deadlines. Thus, the dynamic router 130 may be configured to generate the route and schedule for the carriers with the special equipment such that the routes and schedules allow the carriers with the special equipment to perform the customer requests in the most efficient order possible. Thus, at block 510, if the method 500 determines that customer request requires special equipment or a special carrier, then the method proceeds to block 512. If the method 500 determines that the request does not require special equipment or a special carrier, then the method 500 proceeds to block 518.

At block 512, the method 500 comprises determining if the customer request requires special equipment or a special carrier. In some embodiments, the dynamic router 130 or the central processor 110 may perform the determination at block 512. If the customer request requires special equipment, then the method 500 proceeds to block 516. In some embodiments, the special equipment may include any equipment or materials that the carrier may gather and/or collect for use to perform a customer requested service that is not restricted for use by a limited number of carriers. For example, the carrier that typically services a route may acquire the packaging materials needed for a requested PPS or a camera or other monitoring equipment to perform wellness services and provide the photographic evidence desired.

Additionally, or alternatively, as the carrier may need the equipment and/or materials needed to complete multiple customer requests, the dynamic router 130 may need to coordinate all the materials and equipment the carrier on a given route and/or schedule may need so as to efficiently perform all scheduled services and/or item services. Additionally, or alternatively, in some embodiments, the dynamic router 130 may be configured to provide updated routes and/or schedules to one or more carriers based on received customer requests or other events that may occur.

If the customer request requires a special carrier, then the method 500 proceeds to block 516. In some embodiments, a special carrier may be used for requests that involve dedicated equipment that may not be easily transferred between carriers (for example, shredding equipment that is installed in the carrier vehicle in limited quantities) or carriers that are specially trained to perform specific services (such as passport services). Additionally, or alternatively, in some embodiments, the dynamic router 130 may be configured to provide updated routes and/or schedules to one or more special carriers based on received customer requests or other events that may occur. Once both the block 514 and the block 516 have scheduled their respective carriers, the method 500 proceeds to block 520.

At block 518, the dynamic router 130 schedules a carrier that does not require special equipment or that is not a special carrier to perform the customer request(s). In some embodiments, the customer request may only require a carrier pickup and deliver medical or other supplies, which may not require additional equipment or a special carrier. Accordingly, the dynamic router 130 may schedule a carrier that normally services a route or schedule to perform the requested services that do not require any additional equipment/materials or a special carrier. Once scheduling of block 518 is complete, the method 500 proceeds to block 520.

At block 520 of method 500, the scheduled carrier arrives at the customer residence/location and proceeds to block 522. At block 522, the carrier may use the mobile computing device 124 to verify information provided by the customer with regards to the customer request. If the information is verified and the customer request is valid (for example, the carrier can perform the customer's request), then the method 500 proceeds to block 524. At block 524, the carrier performs/provides the requested customer service. Once the service is completed at block 524, the method 500 proceeds to block 528.

If the method 500 determines, at block 522, that the customer request is not valid (for example, the carrier cannot perform the service requested because the customer is not ready for the service to be performed or the service requested cannot be performed by the carrier (for example an item requested for PPS was not ready or available to be picked up and packaged), then the method 500 proceeds to block 526. At block 526, the customer request is canceled and/or rescheduled. After the customer request is canceled and/or rescheduled, the method 500 proceeds to block 528. At block 528, the carrier continues the assigned route/schedule.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

The technology is operational with numerous other general purpose or special purpose computing system environments or configurations. Examples of well-known computing systems, environments, and/or configurations that may be suitable for use with the development include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX® or Microsoft Windows®.

The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

Those of skill will further recognize that the various illustrative logical blocks, modules, circuits, and algorithm steps described in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the present development.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present development. At the very least, and not as an attempt to limit the application of the doctrine of equivalents to the scope of the claims, each numerical parameter should be construed in light of the number of significant digits and ordinary rounding approaches.

The above description discloses several methods and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it cover all modifications and alternatives coming within the true scope and spirit of the development as embodied in the attached claims.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrequited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; and use of terms like ‘preferably,’ ‘preferred,’ ‘desired,’ or ‘desirable,’ and words of similar meaning should not be understood as implying that certain features are critical, essential, or even important to the structure or function, but instead as merely intended to highlight alternative or additional features that may or may not be utilized in a particular embodiment. In addition, the term “comprising” is to be interpreted synonymously with the phrases “having at least” or “including at least”. When used in the context of a process, the term “comprising” means that the process includes at least the recited steps, but may include additional steps. When used in the context of a compound, composition or device, the term “comprising” means that the compound, composition or device includes at least the recited features or components, but may also include additional features or components. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

What is claimed is:

1. A method for receiving and transporting an item to a delivery location, comprising:
receiving, via a customer interface or communication device, a request to transport the item, the request comprising:
a selection of a courier service or a distribution service by which the customer requests the item be transported; and
a detailed description of the item to be transported;
determining, via a processor, if additional packaging is required for the item to be transported based on the selection of the courier service or the distribution service and based on the detailed description of the item to be transported;
determining, by a dynamic router, based on the selection of a courier service or a distribution service in the request, whether to modify an existing route or generate a new route for transportation of the item as requested by the customer;
calculating, by the processor, a fee for transporting the item based on the request to transport the item;
calculating, by the processor, an estimated delivery date based on the request to transport the item;
receiving the item;
packaging the received item in the additional packaging if the additional packaging is determined to be required based on the selection of a type of courier service or a type of distribution service; and
transporting the item to the delivery location according to the selected courier or distribution service for delivery by the estimated delivery date.

2. The method of claim 1, wherein receiving the request comprising the selection of a courier service or a distribution service by which the customer requests the item be transported comprises receiving a customer selected pickup date, a customer selected delivery date, a customer selected pickup location, and a customer selected delivery location and selecting the courier service or the distribution service most appropriate for the customer selected dates and locations.

3. The method of claim 1, wherein the detailed description comprises at least one of estimated dimensions of the item, a weight of the item, a photograph containing reference dimensions of the item, a commercial identifier of the item, and a specification sheet of the item.

4. The method of claim 1, further comprising selecting additional packaging if the additional packaging is determined to be required.

5. The method of claim 4, wherein selecting additional packaging comprises selecting one packaging type from a plurality of packaging types if the user selects a type of distribution service and wherein the plurality of packaging types comprises different packaging types for each different mail service and for different types of items to be transported.

6. The method of claim 1, wherein selecting additional packaging comprises determining a box size in which the item will fit, wherein determining a box size comprises identifying the dimensions of the item from the detailed description and selecting the box size such that the item will fit within the selected box size with proper packaging materials.

7. The method of claim 1, wherein receiving the item to be transported from the customer comprises verifying a condition of the received item and verifying the detailed description of the item to be transported as provided in the request received from the customer.

8. The method of claim 1, wherein determining whether to modify an existing route or generate a new route comprises at least one of determining whether to at least one of modify an existing pickup route and generate a new pickup route and whether to at least one modify of an existing delivery route or generate a new delivery route for transportation of the item as requested by the customer.

9. A system for transporting an item comprising:
an interface configured to receive a request to perform a service, the request comprising:
one or more services to be performed at a location or for a customer, and
the location at which the one or more services are to be performed;
a processor configured to:
determine if additional packaging is required for the item to be transported based on a selection of a courier service or a distribution service and based on a description of the item to be transported,
selecting additional packaging if the additional packaging is determined to be required, and
calculating a fee and postage for transporting the item based on the request to transport the item;
a dynamic router configured to determine, based on the selection of the courier service or the distribution service in the request, whether to modify an existing route or generate a new route for transportation of the item as requested by the customer; and
a delivery resource configured to receive the item; and
transport the item to the delivery location in the additional packaging according to the selected courier or distribution service for delivery by the estimated delivery date.

10. The system of claim 9, wherein the request further comprises one or more of a customer selected pickup date, a customer selected delivery date, a customer selected pickup location, and a customer selected delivery location and a selection of the courier service or the distribution service most appropriate for the customer selected dates and locations.

11. The system of claim 9, wherein the detailed description comprises at least one of estimated dimensions of the item, a weight of the item, a photograph containing reference dimensions of the item, a commercial identifier of the item, and a specification sheet of the item.

12. The system of claim 9, wherein the processor is further configured to select additional packaging if the additional packaging is determined to be required.

13. The system of claim 12, wherein selecting additional packaging comprises selecting one packaging type from a plurality of packaging types based on a type of distribution service requested and wherein the plurality of packaging types comprises different packaging types for each different mail service and for different types of items to be transported.

14. The system of claim 9, wherein the processor is further configured to determine a box size for the item, wherein determining a box size comprises identifying the dimensions of the item from the detailed description and selecting the box size such that the item will fit within the selected box size with proper packaging materials.

15. The system of claim 9, wherein the delivery resource is further configured to verify a condition of the received item and verify the detailed description of the item to be transported as provided in the request received from the customer.

16. The system of claim 9, wherein the dynamic router determining whether to modify an existing route or generate a new route comprises at least one of determining whether to at least one of modify an existing pickup route and generate a new pickup route and whether to at least one modify of an existing delivery route or generate a new delivery route for transportation of the item as requested by the customer.

17. An apparatus for receiving and transporting an item to a delivery location, comprising:
means for receiving a request to transport the item, the request comprising:
a selection of a courier service or a distribution service by which the customer requests the item be transported; and
a detailed description of the item to be transported;
means for determining if additional packaging is required for the item to be transported based on the selection of the courier service or the distribution service and based on the detailed description of the item to be transported;
means for determining based on the selection of a courier service or a distribution service in the request, whether to modify an existing route or generate a new route for transportation of the item as requested by the customer;
means for calculating a fee for transporting the item based on the request to transport the item;
means for calculating an estimated delivery date based on the request to transport the item;
means for receiving the item;
means for packaging the received item in the additional packaging if the additional packaging is determined to be required based on the selection of a type of courier service or a type of distribution service; and
means for transporting the item to the delivery location according to the selected courier or distribution service for delivery by the estimated delivery date.
